(19) United States
(12) Patent Application Publication
(10) Pub. No.: US 2003/0004590 A1
(43) Pub. Date: Jan. 2, 2003

(54) Digital sound processing program executing apparatus, a digital sound processing program executing method, a machine readable media, and a digital audio sound processing system

(76) Inventors: Ryoji Abe, Yokohama-shi (JP); Satoshi Kurita, Yokohama-shi (JP)

Correspondence Address: PEARNE & GORDON LLP, 526 SUPERIOR AVENUE EAST, SUITE 1200, CLEVELAND, OH, 44114-1484, US

(21) Appl. No.: 10/166,230

(22) Filed: Jun. 5, 2002

(30) Foreign Application Priority Data
Jun. 5, 2001 (JP) 2001-169491

(51) Int. Cl. G06F 17/00

(52) U.S. Cl. 700/94

(57) ABSTRACT

A digital sound processing program executing apparatus 100 for executing a digital sound processing program after producing said digital sound processing program from a plurality of subprograms, each of said subprograms being associated with an icon image, comprising: icon image displaying means 105 for displaying each of said icon images indicative of said subprograms of said digital sound processing program, said icon image displaying means 105 being constituted by a monitor screen, digital sound data storing means 116 for storing said digital sound data, second subprogram storing means 117 for storing said data reading subprogram, subprogram classifying means 120 for classifying each of said preceding subprogram and said following subprograms on the basis of said block diagram indicative of said digital sound processing program displayed by said icon image displaying means 105, subprogram linking means 125 for linking said preceding subprogram with each of said following subprograms on the basis of said block diagram indicative of said digital sound processing program displayed by said icon image displaying means 105, subprogram judging means 130 for judging whether or not said subprogram linking means 125 is operative to link said preceding subprogram with each of said following subprograms through said reading subprogram on the basis of said block diagram indicative of said digital sound signal processing subprogram displayed by said icon image displaying means 105, executable program producing means 135 for producing a targeted executable program from said subprograms linked by said subprogram linking means 125, and executable program executing means 150 for executing said targeted executable program produced by said executable program producing means 135.

### BACKGROUND OF THE INVENTION

1. Field of the Invention

The present invention relates to a digital sound processing program executing apparatus, a digital sound processing program executing method, a recordable media, and a digital audio sound processing system, and more particularly to an apparatus for and a method of executing a digital sound processing program after producing the executable program of the digital sound processing program from a plurality of subprograms on the basis of a block diagram of the digital sound processing program displayed in a monitor screen.

2. Description of the Related Art

Such a digital sound processing program executing apparatus is, in general, available for producing an executable program of the digital sound processing program from an algorithm of the digital sound processing program without a sophisticated technical knowledge on the computer programming language to process the digital sound with various forms of the application.

Up until now, there have been proposed a wide variety of digital sound processing program executing apparatuses as will be seen for example in U.S. Pat. No. 5,862,231. The conventional digital sound processing program executing apparatus 10 disclosed by the above United States Patent is shown in FIG. 12. The conventional digital sound processing program executing apparatus comprises subprogram storing means 1 for storing a plurality of subprograms, selecting means 2 for selecting the subprograms stored by the subprogram storing means 1 on the basis of the digital sound processing program, displaying means 3 for displaying the subprograms to show a digital sound processing program in the form of graphic symbols, the subprograms including a preceding subprogram and a following subprogram to be performed after the preceding subprogram is to be performed, subprogram linking means 4 for linking the preceding subprogram and the following subprogram the basis of the digital signal processing program displayed on the displaying means 3, executable program producing means 5 for producing an executable microprogram from the subprograms linked by the subprogram linking means 4, a digital sound processor 7 for processing a digital sound on the basis of the executable program, and transferring means 6 for transferring the executable program to the digital signal processor 7.

The conventional digital sound processing program executing apparatus thus constructed in the above encounters such a problem that each of the digital sound processing programs requested by an operator obliges each of the subprograms to be performed in a reading stage to ensure that each of the following subprograms is performed to receive the digital sound data in the reading stage after the preceding subprogram is performed to discharge the digital sound data in the writing stage, so that each of the subprograms is required to be previously stored in the subprogram storing means.

Another problem is that the subprograms stored by the subprogram storing means 1 tend to require the subprogram storing means to increase the memory capacity, thereby forcing all of the subprograms to be prepared before producing each of the digital sound processing programs requested by an operator.

### SUMMARY OF THE INVENTION

It is, therefore, an object of the present invention to provide a digital sound processing program executing apparatus, a digital sound processing program executing method, a recordable media, and a digital audio sound processing system which can prevent the subprogram storing means from increasing the memory capacity for all of the subprograms to produce each of the digital sound processing programs requested by an operator.

It is another object of the present invention to provide a digital sound processing program executing apparatus, a digital sound processing program executing method, a recordable media, and a digital audio sound processing system which can prevent each of the following subprograms from performing in the reading stage to ensure that each of the following subprograms is performed to receive the digital sound data through the reading subprogram performed to read the digital sound data stored by the memory in the reading stage after the preceding subprogram is performed to discharge the digital sound data in the writing stage.

The first aspect of the digital sound processing program executing apparatus according to the present invention, comprising: icon image displaying means for displaying the icon images indicative of the subprograms of the digital sound processing program, the icon image displaying means being constituted by a monitor screen, the subprograms including a preceding subprogram and a plurality of following subprograms to be performed after the preceding subprogram is to be performed, each of the preceding subprogram and the following subprograms being to be performed in a processing stage, the icon images including a first icon image indicative of the preceding subprogram and a plurality of second icon images indicative of the following subprograms, the subprograms further including a reading subprogram to be performed in a reading stage; icon images connecting means for connecting the first icon image with each of the second icon images to allow the icon image displaying means to show the digital sound processing program; subprogram storing means for storing the subprograms; subprogram transferring means for transferring the subprograms out of the subprogram storing means; subprogram linking means for linking the preceding subprogram with each of the following subprograms through the reading subprogram on the basis of the digital sound signal processing program displayed by the icon image displaying means; linked subprogram judging means for judging whether or not the subprogram linking means is operative to link the preceding subprogram with each of the following subprograms through the reading subprogram on the basis of the digital sound signal processing program displayed by the icon image displaying means; executable program producing means for producing a targeted executable program from the subprograms linked by the subprogram linking means; executable program storing means for storing the targeted executable program; executable program transferring means for transferring the targeted executable program into the executable program storing means; and executable program executing means for executing the targeted executable program stored by the executable program storing means.

The second aspect of the digital sound processing program executing method according to the present invention, comprising: a preparing step of preparing: icon image displaying means for displaying the icon images indicative of the subprograms of the digital sound processing program, the icon image displaying means being constituted by a monitor screen, the subprograms including a preceding subprogram and a plurality of following subprograms to be performed after the preceding subprogram is to be performed, each of the preceding subprogram and the following subprograms being to be performed in a processing stage, the icon images including a first icon image indicative of the preceding subprogram and a plurality of second icon images indicative of the following subprograms, the subprograms further including a reading subprogram to be performed in a reading stage; icon images connecting means for connecting the first icon image with each of the second icon images to allow the icon image displaying means to show the digital sound processing program; subprogram storing means for storing the subprograms; subprogram transferring means for transferring the subprograms out of the subprogram storing means; subprogram linking means for linking the preceding subprogram with each of the following subprograms through the reading subprogram on the basis of the digital sound signal processing program displayed by the icon image displaying means; linked subprogram judging means for judging whether or not the subprogram linking means is operative to link the preceding subprogram with each of the following subprograms through the reading subprogram on the basis of the digital sound signal processing program displayed by the icon image displaying means; executable program producing means for producing a targeted executable program from the subprograms linked by the subprogram linking means; executable program storing means for storing the targeted executable program; executable program transferring means for transferring the targeted executable program into the executable program storing means; and executable program executing means for executing the targeted executable program stored by the executable program storing means, and icon image displaying step of displaying the icon images indicative of the subprograms of the digital sound processing program, the icon image displaying means being constituted by a monitor screen, the subprograms including a preceding subprogram and a plurality of following subprograms to be performed after the preceding subprogram is to be performed, each of the preceding subprogram and the following subprograms being to be performed in a processing stage, the icon images including a first icon image indicative of the preceding subprogram and a plurality of second icon images indicative of the following subprograms, the subprograms further including a reading subprogram to be performed in a reading stage; icon images connecting step of connecting the first icon image with each of the second icon images to allow the icon image displaying means to show the digital sound processing program; subprogram storing step of storing the subprograms; subprogram transferring step of transferring the subprograms out of the subprogram storing means; subprogram linking step of linking the preceding subprogram with each of the following subprograms through the reading subprogram on the basis of the digital sound signal processing program displayed by the icon image displaying means; linked subprogram judging step of judging whether or not the subprogram linking means is operative to link the preceding subprogram with each of the following subprograms through the reading subprogram on the basis of the digital sound signal processing program displayed by the icon image displaying means; executable program producing step of producing a targeted executable program from the subprograms linked by the subprogram linking means; executable program storing step of storing the targeted executable program; executable program transferring step of transferring the targeted executable program into the executable program storing means; and executable program executing step of executing the targeted executable program stored by the executable program storing means.

The third aspect of the recordable media according to present invention comprising: icon image displaying step of displaying the icon images indicative of the subprograms of the digital sound processing program, the icon image displaying means being constituted by a monitor screen, the subprograms including a preceding subprogram and a plurality of following subprograms to be performed after the preceding subprogram is to be performed, each of the preceding subprogram and the following subprograms being to be performed in a processing stage, the icon images including a first icon image indicative of the preceding subprogram and a plurality of second icon images indicative of the following subprograms, the subprograms further including a reading subprogram to be performed in a reading stage; icon images connecting step of connecting the first icon image with each of the second icon images to allow the icon image displaying means to show the digital sound processing program; subprogram storing step of storing the subprograms; subprogram transferring step of transferring the subprograms out of the subprogram storing means; subprogram linking step of linking the preceding subprogram with each of the following subprograms through the reading subprogram on the basis of the digital sound signal processing program displayed by the icon image displaying means; linked subprogram judging step of judging whether or not the subprogram linking means is operative to link the preceding subprogram with each of the following subprograms through the reading subprogram on the basis of the digital sound signal processing program displayed by the icon image displaying means; executable program producing step of producing a targeted executable program from the subprograms linked by the subprogram linking means; executable program storing step of storing the targeted executable program; executable program transferring step of transferring the targeted executable program into the executable program storing means; and executable program executing step of executing the targeted executable program stored by the executable program storing means.

The fourth aspect of the digital audio sound processing system according to present invention comprising: comprising: icon image displaying means for displaying the icon images indicative of the subprograms of the digital sound processing program, the icon image displaying means being constituted by a monitor screen, the subprograms including a preceding subprogram and a plurality of following subprograms to be performed after the preceding subprogram is to be performed, each of the preceding subprogram and the following subprograms being to be performed in a processing stage, the icon images including a first icon image indicative of the preceding subprogram and a plurality of second icon images indicative of the following subprograms, the subprograms further including a reading subprogram to be performed in a reading stage; icon images connecting means for connecting the first icon image with each of the second icon images to allow the icon image displaying means to show the digital sound processing program; subprogram storing means for storing the subprograms; subprogram transferring means for transferring the subprograms out of the subprogram storing means; subprogram linking means for linking the preceding subprogram with each of the following subprograms through the reading subprogram on the basis of the digital sound signal processing program displayed by the icon image displaying means; linked subprogram judging means for judging whether or not the subprogram linking means is operative to link the preceding subprogram with each of the following subprograms through the reading subprogram on the basis of the digital sound signal processing program displayed by the icon image displaying means; executable program producing means for producing a targeted executable program from the subprograms linked by the subprogram linking means; executable program storing means for storing the targeted executable program; executable program transferring means for transferring the targeted executable program into the executable program storing means; and executable program executing means for executing the targeted executable program stored by the executable program storing means.

### BRIEF DESCRIPTION OF THE DRAWINGS

The present invention and many of the advantages thereof will be better understood from the following detailed description when considered in connection with the accompanying drawings, wherein:

FIG. 1 is a schematic block diagram of the first embodiment of the digital sound processing program executing apparatus according to present invention;

FIG. 2 is a schematic block diagram of the digital sound processing program which is associated with the icon images indicative of the subprograms through a line indicative of the subprogram with one another;

FIG. 3 is a schematic table showing the subprograms connected by the subprogram connecting means and the input data associated with the subprograms;

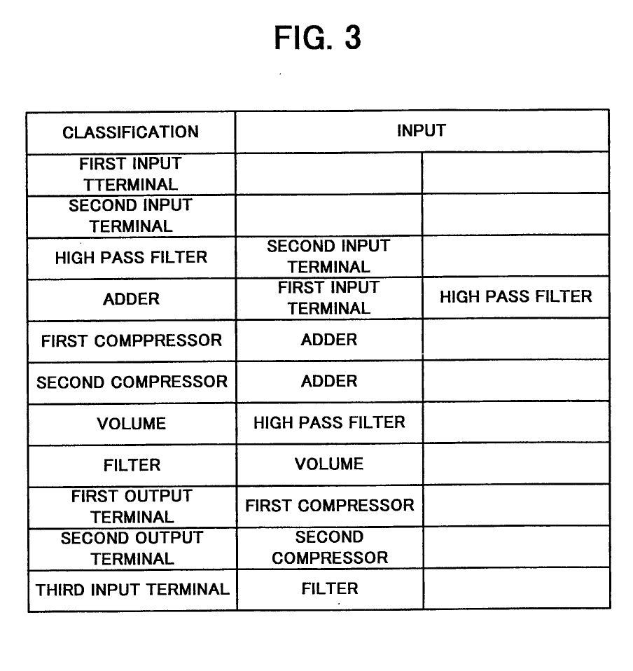

FIG. 4 is a schematic table with the address of each of the output data of the subprograms stored by the digital sound data storing means and the contents associated with the address;

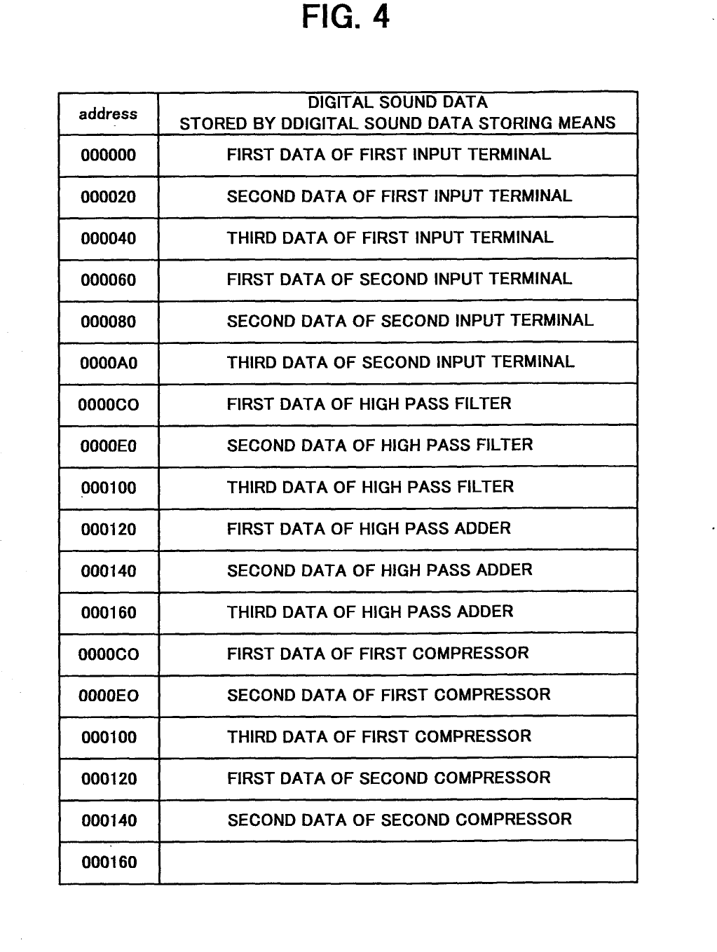

FIG. 5 is a schematic block diagram of the second embodiment of the digital sound processing program executing apparatus according to present invention;

FIG. 6 is a schematic block diagram of the process of processing a digital sound data in the processing stage to perform each of the subprograms and in the reading stage to perform each of the subprograms along the time axis;

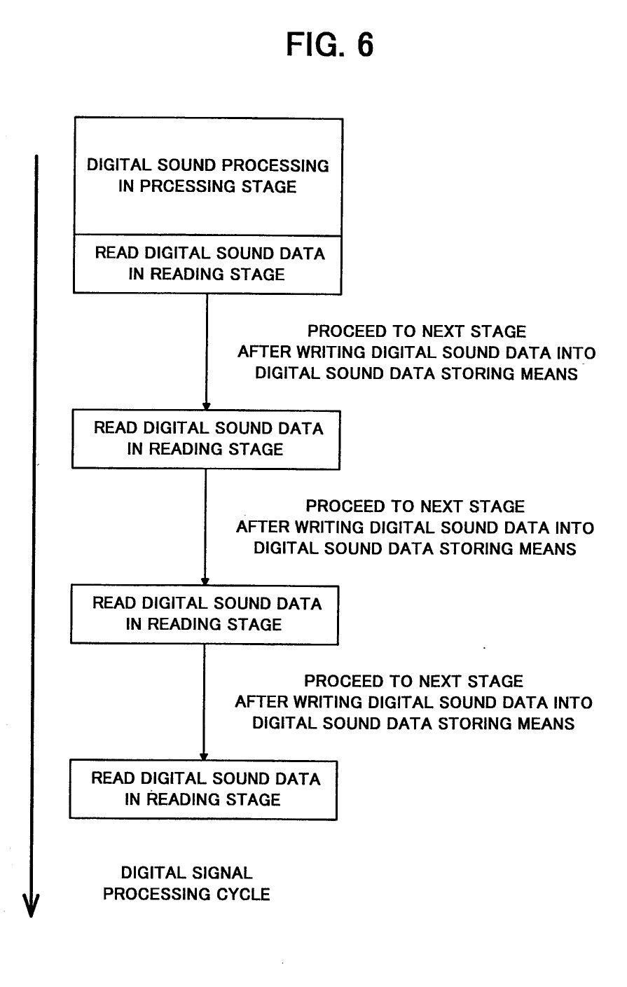

FIG. 7 is a schematic block diagram of the process of processing a digital sound data to execute each of the subprogram to be performed in each of the processing stages and in each of the reading stages along the time axis;

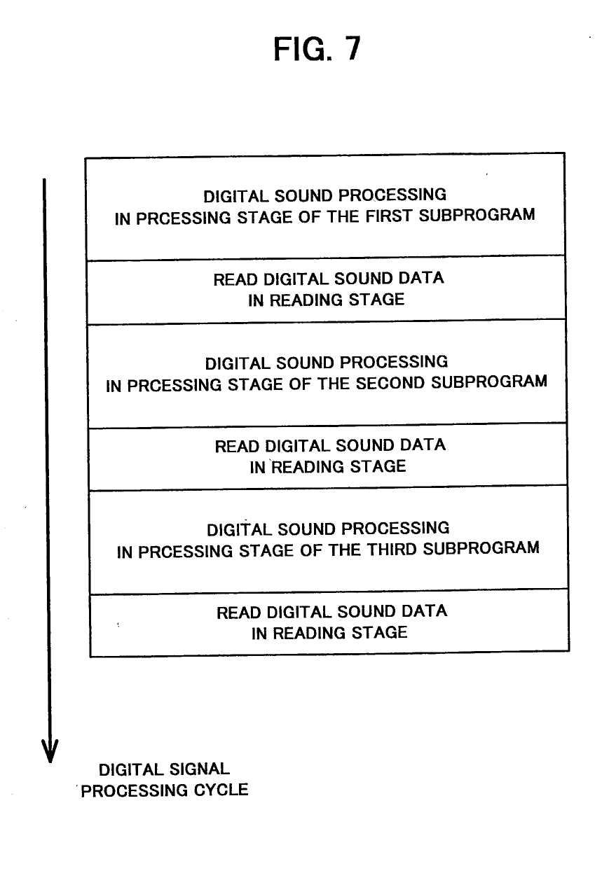

FIG. 8 is a schematic block diagram of the third embodiment of the digital sound processing program executing apparatus according to present invention;

FIG. 9 is a flow chart of the exemplified process of the first embodiment of the digital sound processing program executing apparatus shown in FIG. 1;

FIG. 10 is a flow chart of the exemplified process of the second embodiment of the digital sound processing program executing apparatus shown in FIG. 5;

FIG. 11 is a flow chart of the exemplified process of the third embodiment of the digital sound processing program executing apparatus shown in FIG. 8; and

FIG. 12 is a block diagram of the conventional digital signal processing program executing apparatus.

### DESCRIPTION OF THE PREFERRED EMBODIMENTS

The embodiments of the digital sound processing program executing apparatus according to the present invention will be described in detail hereinafter.

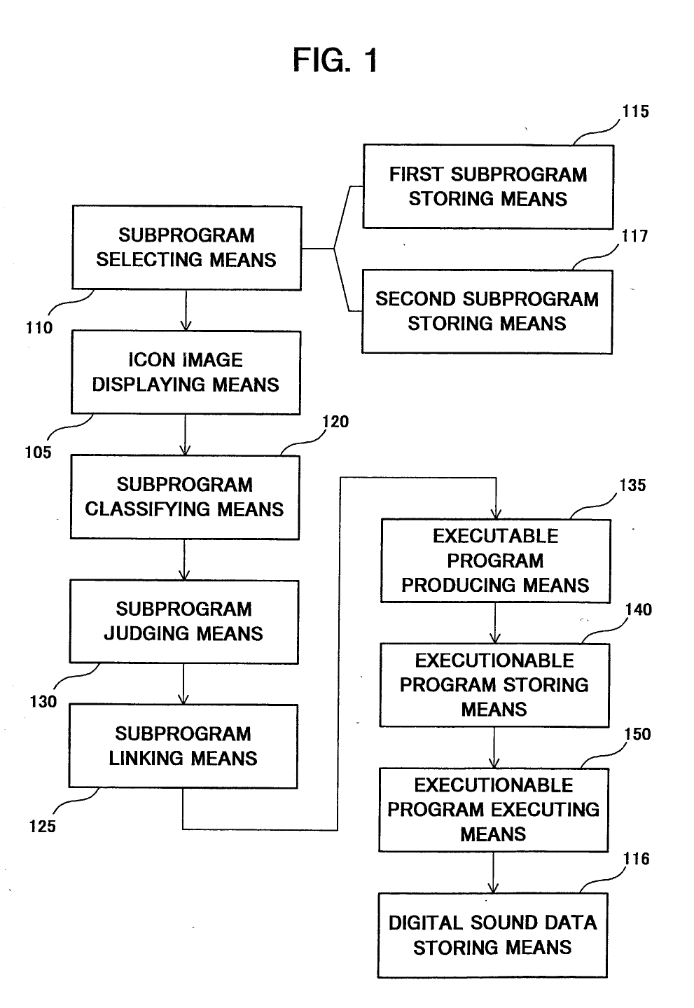

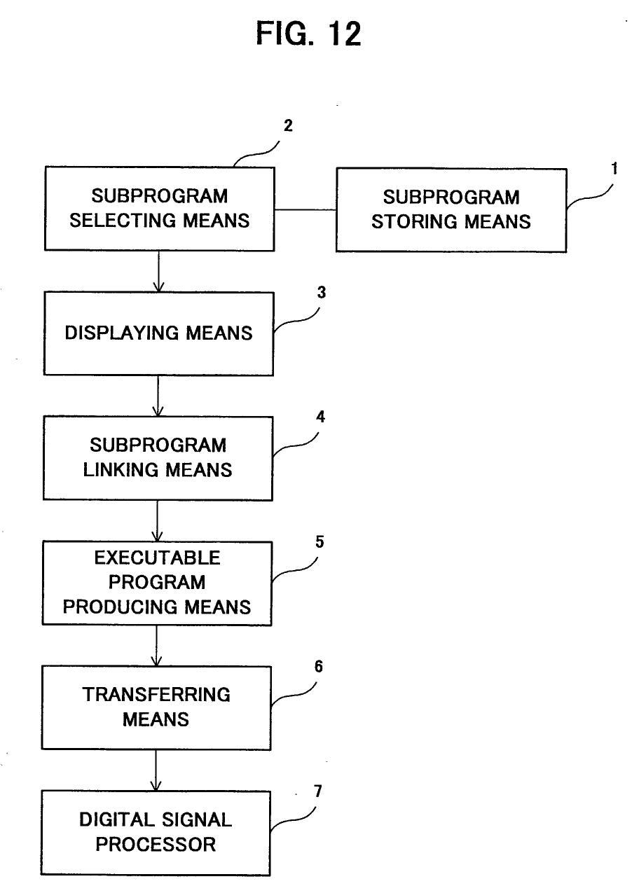

The first embodiment of the digital sound processing program executing apparatus 100 according to the present invention is shown in FIG. 1 as partly similar in construction to the conventional digital sound processing program executing apparatus shown in FIG. 12 and thus comprises icon image displaying means 105 for displaying each of the icon images indicative of the subprograms of the digital sound processing program, the icon image displaying means 105 being constituted by a monitor screen, and the subprograms including a plurality of data processing subprograms and a plurality of data reading subprograms, first subprogram storing means 115 for storing the data processing subprograms, the data processing subprograms including a preceding subprogram and a plurality of following subprograms to be performed after the preceding subprogram is to be performed, the preceding subprogram being to be performed in at least one writing stage after the preceding subprogram is to be performed in at least one processing stage, and each of the following subprograms being to be performed in at least one processing stage, and the icon images including a first icon image indicative of the preceding subprogram and a second icon image indicative of each of the following subprograms, digital sound data storing means 116 for storing the digital sound data, second subprogram storing means 117 for storing the data reading subprogram, each of the data reading subprograms being to be performed in at least one reading stage to read the digital sound data stored by the digital sound data storing means 116, subprogram classifying means 120 for classifying each of the preceding subprogram and the following subprograms on the basis of the block diagram indicative of the digital sound processing program displayed by the icon image displaying means 105, subprogram linking means 125 for linking the preceding subprogram with each of the following subprograms on the basis of the block diagram indicative of the digital sound processing program displayed by the icon image displaying means 105, subprogram judging means 130 for judging whether or not the subprogram linking means 125 is operative to link the preceding subprogram with each of the following subprograms through the reading subprogram on the basis of the block diagram indicative of the digital sound signal processing subprogram displayed by the icon image displaying means 105, executable program producing means 135 for producing a targeted executable program from the subprograms linked by the subprogram linking means 125, and executable program executing means 150 for executing the targeted executable program produced by the executable program producing means 135.

The subprogram linking means 125 is operative to link the preceding subprogram with the following subprogram through the reading subprogram on the basis of the digital sound processing program displayed by the icon image displaying means 105 when the subprogram judging means 130 is operative to judge as the subprogram linking means 125 is operative to link the preceding subprogram with the following subprogram through the reading subprogram on the basis of the subprogram linked by the subprogram linking means 125.

The subprogram linking means 125 is operative to link directly the preceding subprogram with the following subprogram on the basis of the digital sound processing program displayed by the icon image displaying means 105 when the subprogram judging means 130 is operative to judge as the subprogram linking means 125 is operative to link directly the preceding subprogram with one of the following subprograms on the basis of the digital sound processing program displayed by the icon image displaying means 105.

The executable program executing means 150 is operative to execute the targeted executable program stored by the executable program storing means 140 to process the digital sound data in the processing stage of the preceding subprogram before the executable program executing means 150 is operative to execute the targeted executable program stored by the executable program storing means 140 to write the digital sound data processed in the processing stage of the preceding subprogram into the digital sound data storing means in the reading stage of the reading subprogram.

The executable program executing means 150 is operative to execute the targeted executable program stored by the executable program storing means 140 to read the digital sound data stored by the digital sound data storing means in the reading stage of the reading subprogram before the executable program executing means 150 is operative to execute the targeted executable program stored by the executable program storing means 140 to process the digital sound data in the following processing stage of each of the following subprograms. The subprogram selecting means is operative to select each of the subprograms while the icon image displaying means 105 is operative to display the icon image of each of the subprograms selected by the subprogram selecting means. The executable program executing means 150 is constituted by a digital signal processor.

The first embodiment of the digital sound processing program executing apparatus 100 according to the present invention, as described in the above, comprises icon image displaying means 105 for displaying each of the icon images indicative of the subprograms of the digital sound processing program, the icon image displaying means 105 being constituted by a monitor screen, and the subprograms including a plurality of data processing subprograms and a plurality of data reading subprograms, first subprogram storing means 115 for storing the data processing subprograms, the data processing subprograms including a preceding subprogram and a plurality of following subprograms to be performed after the preceding subprogram is to be performed, the preceding subprogram being to be performed in at least one writing stage after the preceding subprogram is to be performed in at least one processing stage, and each of the following subprograms being to be performed in at least one processing stage, and the icon images including a first icon image indicative of the preceding subprogram and a second icon image indicative of each of the following subprograms, digital sound data storing means 116 for storing the digital sound data, second subprogram storing means 117 for storing the data reading subprogram, each of the data reading subprograms being to be performed in at least one reading stage to read the digital sound data stored by the digital sound data storing means 116, subprogram classifying means 120 for classifying each of the preceding subprogram and the following subprograms on the basis of the block diagram indicative of the digital sound processing program displayed by the icon image displaying means 105, subprogram linking means 125 for linking the preceding subprogram with each of the following subprograms on the basis of the block diagram indicative of the digital sound processing program displayed by the icon image displaying means 105, subprogram judging means 130 for judging whether or not the subprogram linking means 125 is operative to link the preceding subprogram with each of the following subprograms through the reading subprogram on the basis of the block diagram indicative of the digital sound signal processing subprogram displayed by the icon image displaying means 105, executable program producing means 135 for producing a targeted executable program from the subprograms linked by the subprogram linking means 125, and executable program executing means 150 for executing the targeted executable program produced by the executable program producing means 135, the executable program executing means 150 being operative to execute the executable program in the writing stage of each of the preceding subprograms to write the digital sound data into the digital sound data storing means 117 after the executable program executing means 150 is operative to execute the executable program in the processing stage of each of the preceding subprograms to process the digital sound data, and the executable program executing means 150 being operative to execute the executable program in the reading stage of each of the reading subprograms to read the digital sound data stored by the digital sound data storing means 117 before the executable program executing means 150 is operative to execute the executable program in the processing stage of the following subprogram to process the digital sound data, and subprogram selecting means for selecting at least two subprograms from among the subprograms stored by the subprogram storing means 115 to allow the icon image displaying means 105 to display the icon images on the monitor screen on the basis of the digital sound processing program, the subprogram selecting means being operative to select each of the subprograms while the icon image displaying means 105 is operative to display the icon image of each of the subprograms selected by the subprogram selecting means.

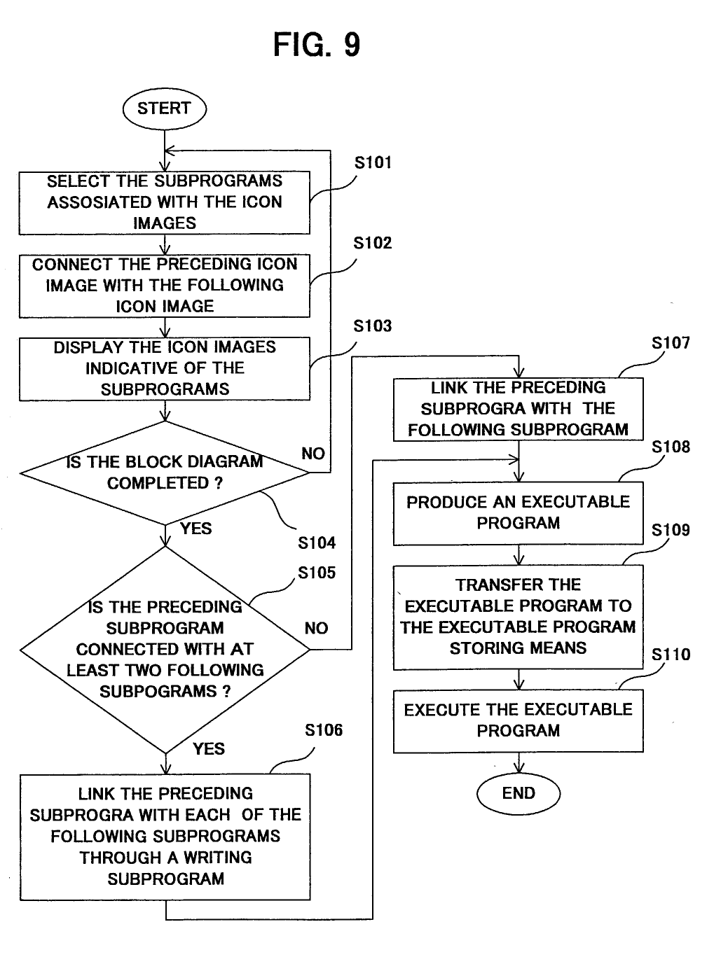

The following description will be directed to the operation of the first embodiment of the digital sound processing program executing apparatus 100 according to the present invention with reference to FIG. 9.

The preparing step is of preparing icon image displaying means 105 for displaying each of the icon images indicative of the subprograms of the digital sound processing program, the icon image displaying means 105 being constituted by a monitor screen, the subprograms including a plurality of data processing subprograms and a plurality of data reading subprograms, first subprogram storing means 115 for storing the data processing subprograms, the data processing subprograms including a preceding subprogram and a plurality of following subprograms to be performed after the preceding subprogram is to be performed, the preceding subprogram being to be performed in at least one writing stage after the preceding subprogram is to be performed in at least one processing stage, and each of the following subprograms being to be performed in at least one processing stage, and the icon images including a first icon image indicative of the preceding subprogram and a second icon image indicative of each of the following subprograms, digital sound data storing means 116 for storing the digital sound data, second subprogram storing means 117 for storing the data reading subprogram, each of the data reading subprograms being to be performed in at least one reading stage to read the digital sound data stored by the digital sound data storing means 116, subprogram classifying means 120 for classifying each of the preceding subprogram and the following subprograms on the basis of the block diagram indicative of the digital sound processing program displayed by the icon image displaying means 105, subprogram linking means 125 for linking the preceding subprogram with each of the following subprograms on the basis of the block diagram indicative of the digital sound processing program displayed by the icon image displaying means 105, subprogram judging means 130 for judging whether or not the subprogram linking means 125 is operative to link the preceding subprogram with each of the following subprograms through the reading subprogram on the basis of the block diagram indicative of the digital sound signal processing subprogram displayed by the icon image displaying means 105, executable program producing means 135 for producing a targeted executable program from the subprograms linked by the subprogram linking means 125, and executable program executing means 150 for executing the targeted executable program produced by the executable program producing means 135, the executable program executing means 150 being operative to execute the executable program in the writing stage of each of the preceding subprograms to write the digital sound data into the digital sound data storing means 117 after the executable program executing means 150 is operative to execute the executable program in the processing stage of each of the preceding subprograms to process the digital sound data, and the executable program executing means 150 being operative to execute the executable program in the reading stage of each of the reading subprograms to read the digital sound data stored by the digital sound data storing means 117 before the executable program executing means 150 is operative to execute the executable program in the processing stage of the following subprogram to process the digital sound data, and the subprogram selecting means for selecting at least two subprograms from among the subprograms stored by the subprogram storing means 115 to allow the icon image displaying means 105 to display the icon images on the monitor screen on the basis of the digital sound processing program, the subprogram selecting means being operative to select each of the subprograms while the icon image displaying means 105 is operative to display the icon image of each of the subprograms selected by the subprogram selecting means.

The subprogram selecting step is of selecting at least two subprograms from among the subprograms stored by the subprogram storing means 115 to allow the icon image displaying means 105 to display the icon images on the monitor screen on the basis of the digital sound processing program, the subprogram selecting means being operative to select each of the subprograms while the icon image displaying means 105 is operative to display the icon image of each of the subprograms selected by the subprogram selecting means. The icon images indicative of the subprograms of the digital sound processing program is displayed by the icon image displaying means 105 in an icon image displaying step S103, the icon image displaying means being constituted by a monitor screen, the subprograms including a preceding subprogram and a following subprogram to be performed after the preceding subprogram is to be performed, each of the preceding subprogram and the following subprogram being to be performed in a processing stage, the icon images including a first icon image indicative of the preceding subprogram and a second icon image indicative of the following subprogram, the subprograms further including a reading subprogram to be performed in a reading stage.

The first icon image with the second icon image is connected by the icon image connecting means in an icon image connecting step to allow the icon image displaying means to show the digital sound processing program. The subprogram storing step is of storing the subprograms. The subprogram transferring step is of transferring the subprograms out of the subprogram storing means. The subprogram linking step is of linking the preceding subprogram with the following subprogram through the reading subprogram on the basis of the digital sound signal processing program displayed by the icon image displaying means. The subprogram judging step is of judging whether or not the subprogram linking means is operative to link the preceding subprogram with the following subprogram through the reading subprogram on the basis of the digital sound signal processing program displayed by the icon image displaying means.

The executable program producing step is of producing a targeted executable program from the subprograms linked by the subprogram linking means. The executable program storing step is of storing the targeted executable program. The executable program transferring step is of transferring the targeted executable program into the executable program storing means. The executable program executing step is of executing the targeted executable program stored by the executable program storing means. The executable program executing means 150 is operative to execute the executable program in the writing stage of the preceding subprogram to write the digital sound data into the digital sound data storing means 117 after the executable program executing means 150 is operative to execute the executable program to process the digital sound data in the processing stage of the preceding subprogram. The executable program executing means 150 is operative to execute the executable program in the reading stage of the reading subprogram to read the digital sound data stored by the digital sound data storing means 117 before the executable program executing means 150 is operative to execute the executable program to process the digital sound data in the processing stage of each of the following subprograms.

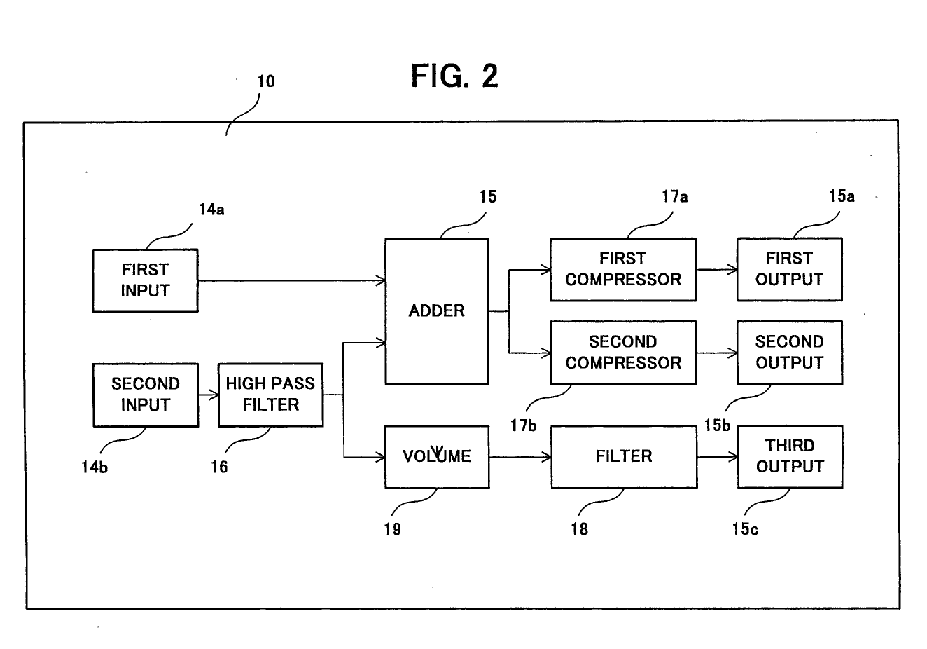

The following description will be directed to the operation of the digital audio system first embodiment of the digital sound processing program executing apparatus 100 according to the present invention with reference to FIG. 2.

The first icon image 14a indicative of the first input subprogram, a second icon image 14b indicative of the second input subprogram, a third icon image 15a indicative of the first output subprogram, a fourth icon image 15b indicative of the second output subprogram, a fifth icon image 15c indicative of the third output subprogram, a sixth icon image 15 indicative of the adder subprogram, a seventh icon image 16 indicative of the high pass filter subprogram, an eighth icon image 17a indicative of the first compressor subprogram, a ninth icon image 17b indicative of the second compressor subprogram, a tenth icon image 18 indicative of the filter subprogram, and an eleventh icon image 19 indicative of the volume subprogram is initially displayed by the icon image displaying means 115.

The recodable media comprises icon image displaying step S103 of displaying each of said icon images indicative of said subprograms of said digital sound processing program, said icon image displaying means 105 being constituted by a monitor screen, and said subprograms including a plurality of data processing subprograms and a plurality of data reading subprograms, first subprogram storing step of storing said data processing subprograms, said data processing subprograms including a preceding subprogram and a plurality of following subprograms to be performed after said preceding subprogram is to be performed, said preceding subprogram being to be performed in at least one writing stage after said preceding subprogram is to be performed in at least one processing stage, and each of said following subprograms being to be performed in at least one processing stage, and said icon images including a first icon image indicative of said preceding subprogram and a second icon image indicative of each of said following subprograms, digital sound data storing step of storing said digital sound data, second subprogram storing step of storing said data reading subprogram, each of said data reading subprograms being to be performed in at least one reading stage to read said digital sound data stored by said digital sound data storing means 116, subprogram classifying step S106 of classifying each of said preceding subprogram and said following subprograms on the basis of said block diagram indicative of said digital sound processing program displayed by said icon image displaying means 105, subprogram linking step S106 of linking said preceding subprogram with each of said following subprograms on the basis of said block diagram indicative of said digital sound processing program displayed by said icon image displaying means 105, subprogram judging step S105 of judging whether or not said subprogram linking means 125 is operative to link said preceding subprogram with each of said following subprograms through said reading subprogram on the basis of said block diagram indicative of said digital sound signal processing subprogram displayed by said icon image displaying means 105, executable program producing step S108 of producing a targeted executable program from said subprograms linked by said subprogram linking means 125, and executable program executing means 150 of executing said targeted executable program produced by said executable program producing means 135, said executable program executing means 150 being operative to execute said executable program in said writing stage of each of said preceding subprograms to write said digital sound data into said digital sound data storing means 117 after said executable program executing means 150 is operative to execute said executable program in said processing stage of each of said preceding subprograms to process said digital sound data, and said executable program executing means 150 being operative to execute said executable program in said reading stage of each of said reading subprograms to read said digital sound data stored by said digital sound data storing means 117 before said executable program executing means 150 is operative to execute said executable program in said processing stage of said following subprogram to process said digital sound data.

The digital audio signal processing system is constituted by the digital sound processing program executing apparatus 100 according to the present invention. The digital audio signal processing system, as will be seen from the above, comprises icon image displaying means 105 for displaying each of the icon images indicative of the subprograms of the digital sound processing program, the icon image displaying means 105 being constituted by a monitor screen, and the subprograms including a plurality of data processing subprograms and a plurality of data reading subprograms, first subprogram storing means 115 for storing the data processing subprograms, the data processing subprograms including a preceding subprogram and a plurality of following subprograms to be performed after the preceding subprogram is to be performed, the preceding subprogram being to be performed in at least one writing stage after the preceding subprogram is to be performed in at least one processing stage, and each of the following subprograms being to be performed in at least one processing stage, and the icon images including a first icon image indicative of the preceding subprogram and a second icon image indicative of each of the following subprograms, digital sound data storing means 116 for storing the digital sound data, second subprogram storing means 117 for storing the data reading subprogram, each of the data reading subprograms being to be performed in at least one reading stage to read the digital sound data stored by the digital sound data storing means 116, subprogram classifying means 120 for classifying each of the preceding subprogram and the following subprograms on the basis of the block diagram indicative of the digital sound processing program displayed by the icon image displaying means 105, subprogram linking means 125 for linking the preceding subprogram with each of the following subprograms on the basis of the block diagram indicative of the digital sound processing program displayed by the icon image displaying means 105, subprogram judging means 130 for judging whether or not the subprogram linking means 125 is operative to link the preceding subprogram with each of the following subprograms through the reading subprogram on the basis of the block diagram indicative of the digital sound signal processing subprogram displayed by the icon image displaying means 105, executable program producing means 135 for producing a targeted executable program from the subprograms linked by the subprogram linking means 125, and executable program executing means 150 for executing the targeted executable program produced by the executable program producing means 135, the executable program executing means 150 being operative to execute the executable program in the writing stage of each of the preceding subprograms to write the digital sound data into the digital sound data storing means 117 after the executable program executing means 150 is operative to execute the executable program in the processing stage of each of the preceding subprograms to process the digital sound data, and the executable program executing means 150 being operative to execute the executable program in the reading stage of each of the reading subprograms to read the digital sound data stored by the digital sound data storing means 117 before the executable program executing means 150 is operative to execute the executable program in the processing stage of the following subprogram to process the digital sound data, and subprogram selecting means for selecting at least two subprograms from among the subprograms stored by the subprogram storing means 115 to allow the icon image displaying means 105 to display the icon images on the monitor screen on the basis of the digital sound processing program, the subprogram selecting means being operative to select each of the subprograms while the icon image displaying means 105 is operative to display the icon image of each of the subprograms selected by the subprogram selecting means.

From the above detailed description, it will be understood that the digital sound processing program executing apparatus 100 can ensure the interface between the preceding subprogram and the following subprogram on the basis of the digital sound processing program requested by an operator so that the following subprogram is performed to receive the digital sound data in the reading stage after the preceding subprogram performs to discharge the digital sound data in the writing stage.

Although there has been described in the above about the first embodiment of the digital sound processing program executing apparatus according to the present invention, this embodiment may be replaced by the second and third embodiments of the digital sound processing program executing apparatus according to the present invention in order to attain the objects of the present invention. The second and third embodiments of the digital sound processing program executing apparatus will then be described hereinafter.

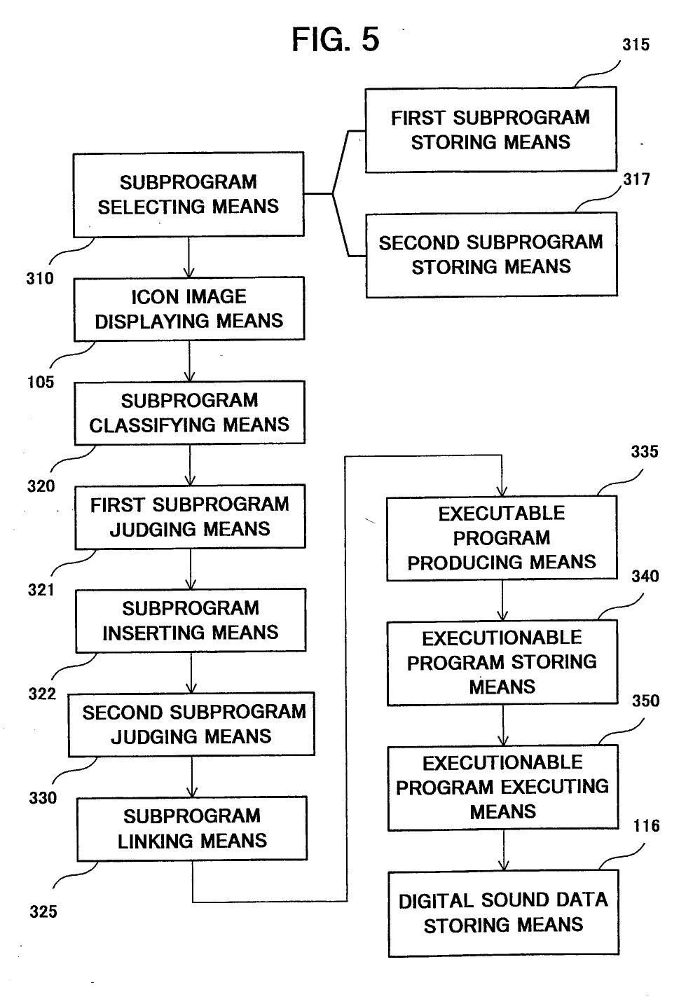

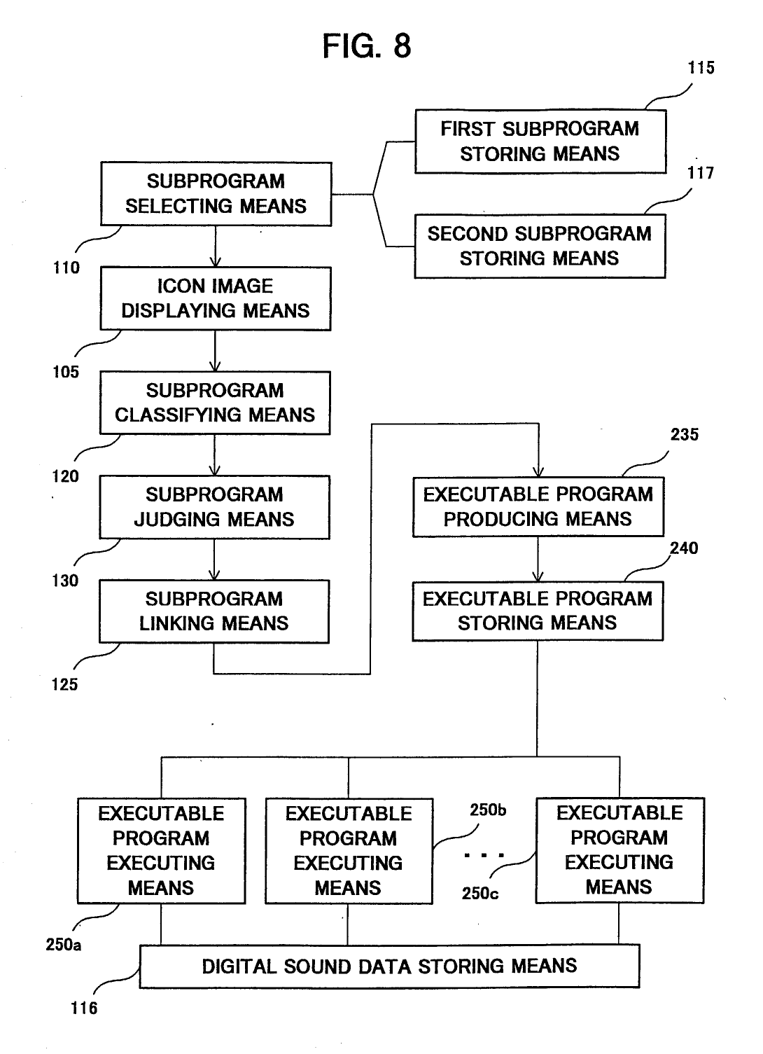

Referring then to FIGS. 5 and 8 of the drawings, there are shown block diagrams of the second and third preferred embodiments of the digital sound processing program executing apparatus according to the present invention. The constitution elements and the steps of the second and third embodiments of the digital sound processing program executing apparatus according to the present invention as shown in FIGS. 5 and 8 are entirely the same as those of the first embodiment of the digital sound processing program executing apparatus according to the present invention as shown in FIG. 1 except for the constitution elements and the steps appearing in the following description. Therefore, only the constitution elements and the steps of the second and third embodiments of the digital sound processing program executing apparatus different from those of the first embodiment of the digital sound processing program executing apparatus will be described in detail hereinafter. The constitution elements and the steps of the second and third embodiments of the digital sound processing program executing apparatus entirely the same as those of the first embodiment of the digital sound processing program executing apparatus will not be described but bear the same reference numerals and legends as those of the first embodiment of the digital sound processing program executing apparatus in FIG. 2 to avoid tedious repetition.

The following description will be directed to the constitution elements and the steps of the second embodiment of the digital sound processing program executing apparatus 200 different from those of the first embodiment of the digital sound processing program executing apparatus.

In addition to icon image displaying means 105, first subprogram storing means 115, second subprogram storing means 117, digital sound data storing means 116, subprogram classifying means 120, subprogram linking means 125, subprogram judging means 130, the second embodiment of the digital sound processing program executing apparatus 200 according to the present invention is shown in FIG. 5 as partly similar in construction to the conventional digital sound processing program executing apparatus shown in FIG. 12 and as further comprising executable program producing means 235 for producing a plurality of targeted executable program from the subprograms linked by the subprogram linking means 125, the targeted executable program including a first executable program and a second executable program, the first executable program being to be performed in each of the processing stage and the writing stage of the preceding subprogram, and the second executable program being to be performed in the reading stage of the reading subprogram and in each of the processing stages of the following subprogram.

The second embodiment of the digital sound processing program executing apparatus 200 according to the present invention further comprises a plurality of executable program executing means 150 for executing the targeted executable program produced by the executable program producing means 135, the executable program executing means 250 having a first executable program executing means 250a and a second executable program executing means 250b, the first executable program executing means 250a being operative to execute the first executable program to process the digital sound data in the processing stage of the preceding subprogram before the first executable program executing means 250a is operative to execute the first executable program to write the digital sound data processed in the processing stage into the digital sound data storing means 116, and the second executable program executing means 250b being operative to execute the second executable program to read the digital sound data stored by the digital sound data storing means 116 in the reading stage of the reading subprogram before the second executable program executing means 250b is operative to execute the second executable program to process the digital sound data read in the reading stage of the reading subprogram in each of the processing stages of the following subprogram.

The second embodiment of the digital sound processing program executing apparatus 200 according to the present invention, as described in the above, comprises icon image displaying means 105 for displaying each of the icon images indicative of the subprograms of the digital sound processing program, the icon image displaying means 105 being constituted by a monitor screen, and the subprograms including a plurality of data processing subprograms and a plurality of data reading subprograms, first subprogram storing means 115 for storing the data processing subprograms, the data processing subprograms including a preceding subprogram and a plurality of following subprograms to be performed after the preceding subprogram is to be performed, the preceding subprogram being to be performed in at least one writing stage after the preceding subprogram is to be performed in at least one processing stage, and each of the following subprograms being to be performed in at least one processing stage, and the icon images including a first icon image indicative of the preceding subprogram and a second icon image indicative of each of the following subprograms, digital sound data storing means 116 for storing the digital sound data, second subprogram storing means 117 for storing the data reading subprogram, each of the data reading subprograms being to be performed in at least one reading stage to read the digital sound data stored by the digital sound data storing means 116, subprogram classifying means 120 for classifying each of the preceding subprogram and the following subprograms on the basis of the block diagram indicative of the digital sound processing program displayed by the icon image displaying means 105, subprogram linking means 125 for linking the preceding subprogram with each of the following subprograms on the basis of the block diagram indicative of the digital sound processing program displayed by the icon image displaying means 105, subprogram judging means 130 for judging whether or not the subprogram linking means 125 is operative to link the preceding subprogram with each of the following subprograms through the reading subprogram on the basis of the block diagram indicative of the digital sound signal processing subprogram displayed by the icon image displaying means 105, executable program producing means 235 for producing a plurality of targeted executable program from the subprograms linked by the subprogram linking means 125, the targeted executable program including a first executable program and a second executable program, the first executable program being to be performed in each of the processing stage and the writing stage of the preceding subprogram, and the second executable program being to be performed in the reading stage of the reading subprogram and in each of the processing stages of the following subprogram, and a plurality of executable program executing means 250 for executing the targeted executable program produced by the executable program producing means 335, the executable program executing means 250 having a first executable program executing means 250a and a second executable program executing means 250b, the first executable program executing means 250a being operative to execute the first executable program to process the digital sound data in the processing stage of the preceding subprogram before the first executable program executing means 250a is operative to execute the first executable program to write the digital sound data processed in the processing stage into the digital sound data storing means 116, and the second executable program executing means 250b being operative to execute the second executable program to read the digital sound data stored by the digital sound data storing means 116 in the reading stage of the reading subprogram before the second executable program executing means 250b is operative to execute the second executable program to process the digital sound data read in the reading stage of the reading subprogram in each of the processing stages of the following subprogram.

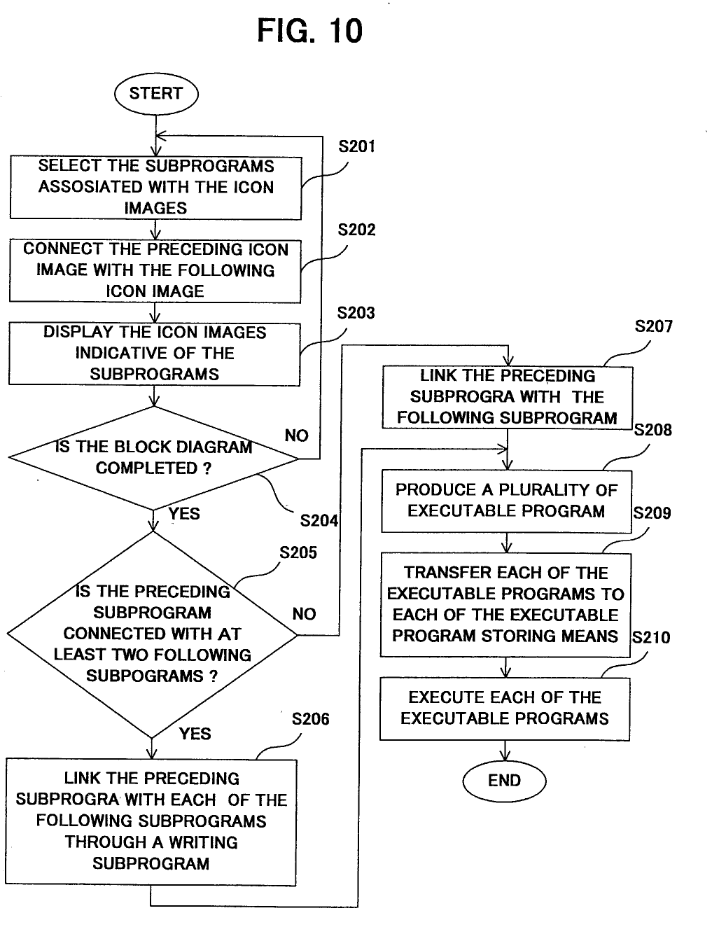

The following description will be directed to the operation of the second embodiment of the digital sound processing program executing apparatus 200 according to the present invention with reference to FIG. 10.

The preparing step is of preparing: icon image displaying means 105 for displaying each of the icon images indicative of the subprograms of the digital sound processing program, the icon image displaying means 105 being constituted by a monitor screen, and the subprograms including a plurality of data processing subprograms and a plurality of data reading subprograms, first subprogram storing means 115 for storing the data processing subprograms, the data processing subprograms including a preceding subprogram and a plurality of following subprograms to be performed after the preceding subprogram is to be performed, the preceding subprogram being to be performed in at least one writing stage after the preceding subprogram is to be performed in at least one processing stage, and each of the following subprograms being to be performed in at least one processing stage, and the icon images including a first icon image indicative of the preceding subprogram and a second icon image indicative of each of the following subprograms, digital sound data storing means 116 for storing the digital sound data, second subprogram storing means 117 for storing the data reading subprogram, each of the data reading subprograms being to be performed in at least one reading stage to read the digital sound data stored by the digital sound data storing means 116, subprogram classifying means 120 for classifying each of the preceding subprogram and the following subprograms on the basis of the block diagram indicative of the digital sound processing program displayed by the icon image displaying means 105, subprogram linking means 125 for linking the preceding subprogram with each of the following subprograms on the basis of the block diagram indicative of the digital sound processing program displayed by the icon image displaying means 105, subprogram judging means 130 for judging whether or not the subprogram linking means 125 is operative to link the preceding subprogram with each of the following subprograms through the reading subprogram on the basis of the block diagram indicative of the digital sound signal processing subprogram displayed by the icon image displaying means 105, executable program producing means 235 for producing a plurality of targeted executable program from the subprograms linked by the subprogram linking means 125, the targeted executable program including a first executable program and a second executable program, the first executable program being to be performed in each of the processing stage and the writing stage of the preceding subprogram, and the second executable program being to be performed in the reading stage of the reading subprogram and in each of the processing stages of the following subprogram, a plurality of executable program executing means 250 for executing the targeted executable program produced by the executable program producing means 335, the executable program executing means 250 having a first executable program executing means 250a and a second executable program executing means 250b, the first executable program executing means 250a being operative to execute the first executable program to process the digital sound data in the processing stage of the preceding subprogram before the first executable program executing means 250a is operative to execute the first executable program to write the digital sound data processed in the processing stage into the digital sound data storing means 116, and the second executable program executing means 250b being operative to execute the second executable program to read the digital sound data stored by the digital sound data storing means 116 in the reading stage of the reading subprogram before the second executable program executing means 250b is operative to execute the second executable program to process the digital sound data read in the reading stage of the reading subprogram in each of the processing stages of the following subprogram, and the executable program executing means 150 being operative to execute the executable program in the reading stage of each of the reading subprograms to read the digital sound data stored by the digital sound data storing means 117 before the executable program executing means 150 is operative to execute the executable program in the processing stage of the following subprogram to process the digital sound data, and the subprogram selecting means for selecting at least two subprograms from among the subprograms stored by the subprogram storing means 115 to allow the icon image displaying means 105 to display the icon images on the monitor screen on the basis of the digital sound processing program, the subprogram selecting means being operative to select each of the subprograms while the icon image displaying means 105 is operative to display the icon image of each of the subprograms selected by the subprogram selecting means.

The subprogram selecting step is of selecting at least two subprograms from among the subprograms stored by the subprogram storing means 115 to allow the icon image displaying means 105 to display the icon images on the monitor screen on the basis of the digital sound processing program, the subprogram selecting means being operative to select each of the subprograms while the icon image displaying means 105 is operative to display the icon image of each of the subprograms selected by the subprogram selecting means.

The icon image displaying step is of displaying the icon images indicative of the subprograms of the digital sound processing program, the icon image displaying means being constituted by a monitor screen, the subprograms including a preceding subprogram and a following subprogram to be performed after the preceding subprogram is to be performed, each of the preceding subprogram and the following subprogram being to be performed in a processing stage, the icon images including a first icon image indicative of the preceding subprogram and a second icon image indicative of the following subprogram, the subprograms further including a reading subprogram to be performed in a reading stage.

The icon image connecting step is of connecting the first icon image with the second icon image to allow the icon image displaying means to show the digital sound processing program. The subprogram storing step is of storing the subprograms. The subprogram transferring step is of transferring the subprograms out of the subprogram storing means. The subprogram linking step is of linking the preceding subprogram with the following subprogram through the reading subprogram on the basis of the digital sound signal processing program displayed by the icon image displaying means.

The subprogram judging step is of judging whether or not the subprogram linking means is operative to link the preceding subprogram with the following subprogram through the reading subprogram on the basis of the digital sound signal processing program displayed by the icon image displaying means. The executable program producing step is of producing a targeted executable program from the subprograms linked by the subprogram linking means. The executable program storing step is of storing the targeted executable program. The executable program transferring step is of transferring the targeted executable program into the executable program storing means. The executable program executing step is of executing the targeted executable program stored by the executable program storing means.

The first executable program executing means 250a is operative to execute the first executable program to process the digital sound data in the processing stage of the preceding subprogram before the first executable program executing means 250a is operative to execute the first executable program to write the digital sound data processed in the processing stage into the digital sound data storing means 116. The second executable program executing means 250b is operative to execute the second executable program to read the digital sound data stored by the digital sound data storing means 116 in the reading stage of the reading subprogram before the second executable program executing means 250b is operative to execute the second executable program to process the digital sound data read in the reading stage of the reading subprogram in each of the processing stages of the following subprogram.

The recodable media comprises icon image displaying step S203 of displaying each of said icon images indicative of said subprograms of said digital sound processing program, said icon image displaying means 105 being constituted by a monitor screen, and said subprograms including a plurality of data processing subprograms and a plurality of data reading subprograms, first subprogram storing step of storing said data processing subprograms, said data processing subprograms including a preceding subprogram and a plurality of following subprograms to be performed after said preceding subprogram is to be performed, said preceding subprogram being to be performed in at least one writing stage after said preceding subprogram is to be performed in at least one processing stage, and each of said following subprograms being to be performed in at least one processing stage, and said icon images including a first icon image indicative of said preceding subprogram and a second icon image indicative of each of said following subprograms, digital sound data storing step of storing said digital sound data, second subprogram storing step of storing said data reading subprogram, each of said data reading subprograms being to be performed in at least one reading stage to read said digital sound data stored by said digital sound data storing means 116, subprogram classifying step S206 of classifying each of said preceding subprogram and said following subprograms on the basis of said block diagram indicative of said digital sound processing program displayed by said icon image displaying means 105, subprogram linking step S206 of linking said preceding subprogram with each of said following subprograms on the basis of said block diagram indicative of said digital sound processing program displayed by said icon image displaying means 105, subprogram judging step S205 of judging whether or not said subprogram linking means 125 is operative to link said preceding subprogram with each of said following subprograms through said reading subprogram on the basis of said block diagram indicative of said digital sound signal processing subprogram displayed by said icon image displaying means 105, executable program producing step S208 of producing a plurality of targeted executable program from said subprograms linked by said subprogram linking means 125, said targeted executable program including a first executable program and a second executable program, said first executable program being to be performed in each of said processing stage and said writing stage of said preceding subprogram, and said second executable program being to be performed in said reading stage of said reading subprogram and in each of said processing stages of said following subprogram, and a plurality of executable program executing step S210 of executing said targeted executable program produced by said executable program producing means 235, said executable program executing means 250 having a first executable program executing means 250a and a second executable program executing means 250b, said first executable program executing means 250a being operative to execute said first executable program to process said digital sound data in said processing stage of said preceding subprogram before said first executable program executing means 250a is operative to execute said first executable program to write said digital sound data processed in said processing stage into said digital sound data storing means 116, and said second executable program executing means 250b being operative to execute said second executable program to read said digital sound data stored by said digital sound data storing means 116 in said reading stage of said reading subprogram before said second executable program executing means 250b is operative to execute said second executable program to process said digital sound data read in said reading stage of said reading subprogram in each of said processing stages of said following subprogram.

The digital audio signal processing system is constituted by the digital sound processing program executing apparatus 200 according to the present invention. The digital audio signal processing system, as will be seen from the above, comprises icon image displaying means 105 for displaying each of the icon images indicative of the subprograms of the digital sound processing program, the icon image displaying means 105 being constituted by a monitor screen, and the subprograms including a plurality of data processing subprograms and a plurality of data reading subprograms, first subprogram storing means 115 for storing the data processing subprograms, the data processing subprograms including a preceding subprogram and a plurality of following subprograms to be performed after the preceding subprogram is to be performed, the preceding subprogram being to be performed in at least one writing stage after the preceding subprogram is to be performed in at least one processing stage, and each of the following subprograms being to be performed in at least one processing stage, and the icon images including a first icon image indicative of the preceding subprogram and a second icon image indicative of each of the following subprograms, digital sound data storing means 116 for storing the digital sound data, second subprogram storing means 117 for storing the data reading subprogram, each of the data reading subprograms being to be performed in at least one reading stage to read the digital sound data stored by the digital sound data storing means 116, subprogram classifying means 120 for classifying each of the preceding subprogram and the following subprograms on the basis of the block diagram indicative of the digital sound processing program displayed by the icon image displaying means 105, subprogram linking means 125 for linking the preceding subprogram with each of the following subprograms on the basis of the block diagram indicative of the digital sound processing program displayed by the icon image displaying means 105, subprogram judging means 130 for judging whether or not the subprogram linking means 125 is operative to link the preceding subprogram with each of the following subprograms through the reading subprogram on the basis of the block diagram indicative of the digital sound signal processing subprogram displayed by the icon image displaying means 105, executable program producing means 235 for producing a plurality of targeted executable program from the subprograms linked by the subprogram linking means 125, the targeted executable program including a first executable program and a second executable program, the first executable program being to be performed in each of the processing stage and the writing stage of the preceding subprogram, and the second executable program being to be performed in the reading stage of the reading subprogram and in each of the processing stages of the following subprogram, and a plurality of executable program executing means 250 for executing the targeted executable program produced by the executable program producing means 335, the executable program executing means 250 having a first executable program executing means 250a and a second executable program executing means 250b, the first executable program executing means 250a being operative to execute the first executable program to process the digital sound data in the processing stage of the preceding subprogram before the first executable program executing means 250a is operative to execute the first executable program to write the digital sound data processed in the processing stage into the digital sound data storing means 116, and the second executable program executing means 250b being operative to execute the second executable program to read the digital sound data stored by the digital sound data storing means 116 in the reading stage of the reading subprogram before the second executable program executing means 250b is operative to execute the second executable program to process the digital sound data read in the reading stage of the reading subprogram in each of the processing stages of the following subprogram.

From the above detailed description, it will be understood that the digital sound processing program executing apparatus 200 can ensure the interface between the preceding subprogram and the following subprogram on the basis of the digital sound processing program requested by an operator so that the following subprogram is performed to receive the digital sound data in the reading stage after the preceding subprogram performs to discharge the digital sound data in the writing stage.

Although there has been described in the above about the first embodiment of the digital sound processing program executing apparatus according to the present invention, this embodiment may be replaced by the second and third embodiments of the digital sound processing program executing apparatus according to the present invention in order to attain the objects of the present invention. The second and third embodiments of the digital sound processing program executing apparatus will then be described hereinafter.

Referring then to FIGS. 5 and 8 of the drawings, there are shown block diagrams of the second and third preferred embodiments of the digital sound processing program executing apparatus according to the present invention. The constitution elements and the steps of the second and third embodiments of the digital sound processing program executing apparatus according to the present invention as shown in FIGS. 5 and 8 are entirely the same as those of the first embodiment of the digital sound processing program executing apparatus according to the present invention as shown in FIG. 1 except for the constitution elements and the steps appearing in the following description. Therefore, only the constitution elements and the steps of the second and third embodiments of the digital sound processing program executing apparatus different from those of the first embodiment of the digital sound processing program executing apparatus will be described in detail hereinafter. The constitution elements and the steps of the second and third embodiments of the digital sound processing program executing apparatus entirely the same as those of the first embodiment of the digital sound processing program executing apparatus will not be described but bear the same reference numerals and legends as those of the first embodiment of the digital sound processing program executing apparatus in FIG. 2 to avoid tedious repetition.

The following description will be directed to the constitution elements and the steps of the third embodiment of the digital sound processing program executing apparatus 300 different from those of the first embodiment of the digital sound processing program executing apparatus.

In addition to icon image displaying means 105, digital sound data storing means 116, second subprogram storing means 117, subprogram linking means 125, the third embodiment of the digital sound processing program executing apparatus 300 to the present invention is shown in FIG. 8 as partly similar in construction to the conventional digital sound processing program executing apparatus shown in FIG. 12 and as further comprising first subprogram storing means 315 for storing the data processing subprograms, each of the data processing subprograms being divided into plurality of short-subprograms, the short-subprograms including a preceding short-subprogram and a following short-subprogram to be performed after the preceding short-subprogram is to be performed, each of the preceding short-subprogram and the following short-subprogram being performed in at least one processing state, subprogram inserting means 318 for inserting the reading subprogram between the preceding short-subprogram and the following short-subprogram on the basis of the block diagram indicative of the digital sound signal processing subprogram displayed by the icon image displaying means 105.

The third embodiment of the digital sound processing program executing apparatus 300 further comprises first subprogram judging means 319 for judging whether or not the subprogram inserting means 318 is operative to insert the reading subprogram between the preceding short-subprogram and the following short-subprogram on the basis of the block diagram indicative of the digital sound signal processing subprogram displayed by the icon image displaying means 105, the data processing subprograms inserted by the subprogram inserting means 318 including a preceding subprogram and a following subprogram to be performed after the preceding subprogram is to be performed, each of the preceding subprogram and the following subprogram being performed in at least one processing state, and second subprogram judging means 330 for judging whether or not the subprogram linking means 125 is operative to link the preceding subprogram with the following subprogram on the basis of the block diagram indicative of the digital sound signal processing subprogram displayed by the icon image displaying means 105.

The third embodiment of the digital sound processing program executing apparatus 300 further comprises executable program producing means 335 for producing a targeted executable program from the subprograms linked by the subprogram linking means 125, executable program executing means 350 for executing the targeted executable program stored by the executable program storing means 140, the executable program executing means 350 being operative to execute the executable program to process the digital sound data in the processing stage of the preceding short-subprogram of the preceding subprogram before the executable program executing means 350 is operative to execute the executable program to read the digital sound data stored by the digital sound data storing means 116 in the reading stage of the reading subprogram, the executable program executing means 350 being operative to execute the executable program to process the digital sound data processed and the digital sound data read the reading stage of the reading subprogram in the processing stage of the following short-subprogram of the preceding subprogram before the executable program executing means 350 is operative to execute the executable program to read the digital sound data stored by the digital sound data storing means 116 in the processing stage of the preceding short-subprogram of the preceding subprogram.

The executable program executing means 350 is operative to execute the executable program to process the digital sound data in the processing stage of the preceding short-subprogram of the preceding subprogram before the executable program executing means 350 is operative to execute the executable program to read the digital sound data stored by the digital sound data storing means 116 in the reading stage of the reading subprogram. The executable program executing means 350 being operative to execute the executable program to process both the digital sound data processed in the processing stage of the preceding short-subprogram of the preceding subprogram and the digital sound data read in the reading stage of the reading subprogram in the processing stage of the following short-subprogram of the preceding subprogram after the executable program executing means 350 is operative to execute the executable program to read the digital sound data stored by the digital sound data storing means 116 in the processing stage of the preceding short-subprogram of the preceding subprogram.

The first embodiment of the digital sound processing program executing apparatus 300 according to the present invention, icon image displaying means 105 for displaying each of the icon images indicative of the subprograms of the digital sound processing program, the icon image displaying means 105 being constituted by a monitor screen, and the subprograms including a plurality of data processing subprograms and a plurality of data reading subprograms, first subprogram storing means 315 for storing the data processing subprograms, each of the data processing subprograms being divided into plurality of short-subprograms, the short-subprograms including a preceding short-subprogram and a following short-subprogram to be performed after the preceding short-subprogram is to be performed, each of the preceding short-subprogram and the following short-subprogram being performed in at least one processing state, digital sound data storing means 116 for storing the digital sound data, second subprogram storing means 117 for storing the data reading subprogram, each of the data reading subprograms being to be performed in at least one reading stage to read the digital sound data stored by the digital sound data storing means 116, subprogram inserting means 318 for inserting the reading subprogram between the preceding short-subprogram and the following short-subprogram on the basis of the block diagram indicative of the digital sound signal processing subprogram displayed by the icon image displaying means 105, first subprogram judging means 319 for judging whether or not the subprogram inserting means 318 is operative to insert the reading subprogram between the preceding short-subprogram and the following short-subprogram on the basis of the block diagram indicative of the digital sound signal processing subprogram displayed by the icon image displaying means 105, the data processing subprograms inserted by the subprogram inserting means 318 including a preceding subprogram and a following subprogram to be performed after the preceding subprogram is to be performed, each of the preceding subprogram and the following subprogram being performed in at least one processing state, subprogram linking means 125 for linking the preceding subprogram with the following subprogram on the basis of the block diagram indicative of the digital sound signal processing subprogram displayed by the icon image displaying means 105, second subprogram judging means 330 for judging whether or not the subprogram linking means 125 is operative to link the preceding subprogram with the following subprogram on the basis of the block diagram indicative of the digital sound signal processing subprogram displayed by the icon image displaying means 105, executable program producing means 335 for producing a targeted executable program from the subprograms linked by the subprogram linking means 125, and executable program executing means 350 for executing the targeted executable program stored by the executable program storing means 140, the executable program executing means 350 being operative to execute the executable program to process the digital sound data in the processing stage of the preceding short-subprogram of the preceding subprogram before the executable program executing means 350 is operative to execute the executable program to read the digital sound data stored by the digital sound data storing means 116 in the reading stage of the reading subprogram, the executable program executing means 350 being operative to execute the executable program to process both the digital sound data processed in the processing stage of the preceding short-subprogram of the preceding subprogram and the digital sound data read in the reading stage of the reading subprogram in the processing stage of the following short-subprogram of the preceding subprogram after the executable program executing means 350 is operative to execute the executable program to read the digital sound data stored by the digital sound data storing means 116 in the processing stage of the preceding short-subprogram of the preceding subprogram.

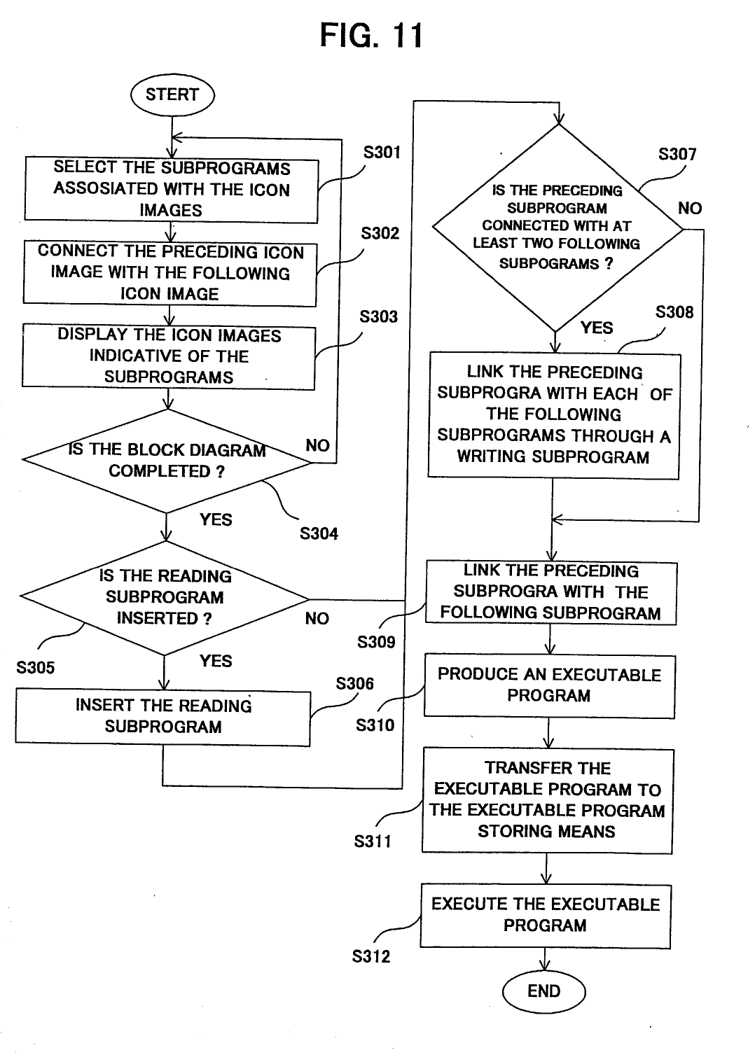

The following description will be directed to the operation of the third embodiment of the digital sound processing program executing apparatus 300 according to the present invention with reference to FIG. 11.

The preparing step is preparing: icon image displaying means 105 for displaying each of the icon images indicative of the subprograms of the digital sound processing program, the icon image displaying means 105 being constituted by a monitor screen, and the subprograms including a plurality of data processing subprograms and a plurality of data reading subprograms, first subprogram storing means 315 for storing the data processing subprograms, each of the data processing subprograms being divided into plurality of short-subprograms, the short-subprograms including a preceding short-subprogram and a following short-subprogram to be performed after the preceding short-subprogram is to be performed, each of the preceding short-subprogram and the following short-subprogram being performed in at least one processing state, digital sound data storing means 116 for storing the digital sound data, second subprogram storing means 117 for storing the data reading subprogram, each of the data reading subprograms being to be performed in at least one reading stage to read the digital sound data stored by the digital sound data storing means 116, subprogram inserting means 318 for inserting the reading subprogram between the preceding short-subprogram and the following short-subprogram on the basis of the block diagram indicative of the digital sound signal processing subprogram displayed by the icon image displaying means 105, first subprogram judging means 319 for judging whether or not the subprogram inserting means 318 is operative to insert the reading subprogram between the preceding short-subprogram and the following short-subprogram on the basis of the block diagram indicative of the digital sound signal processing subprogram displayed by the icon image displaying means 105, the data processing subprograms inserted by the subprogram inserting means 318 including a preceding subprogram and a following subprogram to be performed after the preceding subprogram is to be performed, each of the preceding subprogram and the following subprogram being performed in at least one processing state, subprogram linking means 125 for linking the preceding subprogram with the following subprogram on the basis of the block diagram indicative of the digital sound signal processing subprogram displayed by the icon image displaying means 105, second subprogram judging means 330 for judging whether or not the subprogram linking means 125 is operative to link the preceding subprogram with the following subprogram on the basis of the block diagram indicative of the digital sound signal processing subprogram displayed by the icon image displaying means 105, executable program producing means 335 for producing a targeted executable program from the subprograms linked by the subprogram linking means 125, executable program executing means 350 for executing the targeted executable program stored by the executable program storing means 140, the executable program executing means 350 being operative to execute the executable program to process the digital sound data in the processing stage of the preceding short-subprogram of the preceding subprogram before the executable program executing means 350 is operative to execute the executable program to read the digital sound data stored by the digital sound data storing means 116 in the reading stage of the reading subprogram, the executable program executing means 350 being operative to execute the executable program to process both the digital sound data processed in the processing stage of the preceding short-subprogram of the preceding subprogram and the digital sound data read in the reading stage of the reading subprogram in the processing stage of the following short-subprogram of the preceding subprogram after the executable program executing means 350 is operative to execute the executable program to read the digital sound data stored by the digital sound data storing means 116 in the processing stage of the preceding short-subprogram of the preceding subprogram, and the subprogram selecting means for selecting at least two subprograms from among the subprograms stored by the subprogram storing means 115 to allow the icon image displaying means 105 to display the icon images on the monitor screen on the basis of the digital sound processing program, the subprogram selecting means being operative to select each of the subprograms while the icon image displaying means 105 is operative to display the icon image of each of the subprograms selected by the subprogram selecting means.

The subprogram selecting step is of selecting at least two subprograms from among the subprograms stored by the subprogram storing means 115 to allow the icon image displaying means 105 to display the icon images on the monitor screen on the basis of the digital sound processing program, the subprogram selecting means being operative to select each of the subprograms while the icon image displaying means 105 is operative to display the icon image of each of the subprograms selected by the subprogram selecting means.

The data processing subprograms is initially stored by the first data storing means 315 in the first subprogram storing step S315, each of the data processing subprograms being divided into plurality of short-subprograms, the short-subprograms including a preceding short-subprogram and a following short-subprogram to be performed after the preceding short-subprogram is to be performed, each of the preceding short-subprogram and the following short-subprogram being performed in at least one processing state. The data reading subprogram is then stored by the second subprogram storing means 317 in the second subprogram storing step, each of the data reading subprograms being to be performed in at least one reading stage to read the digital sound data stored by the digital sound data storing means 116.

The icon images indicative of the subprograms of the digital sound processing program is then displayed by the icon image displaying means 315 in the icon image displaying step S105, the icon image displaying means 105 being constituted by a monitor screen, and the subprograms including a plurality of data processing subprograms and a plurality of data reading subprograms. The subprogram inserting step S322 is of inserting the reading subprogram between the preceding short-subprogram and the following short-subprogram on the basis of the block diagram indicative of the digital sound signal processing subprogram displayed by the icon image displaying means 105.

The first subprogram judging step S321 is of judging whether or not the subprogram inserting means 318 is operative to insert the reading subprogram between the preceding short-subprogram and the following short-subprogram on the basis of the block diagram indicative of the digital sound signal processing subprogram displayed by the icon image displaying means 105, the data processing subprograms inserted by the subprogram inserting means 318 including a preceding subprogram and a following subprogram to be performed after the preceding subprogram is to be performed, each of the preceding subprogram and the following subprogram being performed in at least one processing state.

The subprogram linking step S325 is of linking the preceding subprogram with the following subprogram on the basis of the block diagram indicative of the digital sound signal processing subprogram displayed by the icon image displaying means 105. The second subprogram judging step S330 is of judging whether or not the subprogram linking means 325 is operative to link the preceding subprogram with the following subprogram on the basis of the block diagram indicative of the digital sound signal processing subprogram displayed by the icon image displaying means 105.

The targeted executable program is produced by the executable program producing means 335 from the subprograms linked by the subprogram linking means 325 in the executable program producing step S310. The targeted executable program stored by the executable program storing means 140 is executed by the executable program executing means 350 in the executable program executing step S312 , the executable program executing means 350 being operative to execute the executable program to process the digital sound data in the processing stage of the preceding short-subprogram of the preceding subprogram before the executable program executing means 350 is operative to execute the executable program to read the digital sound data stored by the digital sound data storing means 116 in the reading stage of the reading subprogram, the executable program executing means 350 being operative to execute the executable program to process both the digital sound data processed in the processing stage of the preceding short-subprogram of the preceding subprogram and the digital sound data read in the reading stage of the reading subprogram in the processing stage of the following short-subprogram of the preceding subprogram after the executable program executing means 350 is operative to execute the executable program to read the digital sound data stored by the digital sound data storing means 116 in the processing stage of the preceding short-subprogram of the preceding subprogram.

The recodable media comprises icon image displaying step S203 of displaying each of the icon images indicative of the subprograms of the digital sound processing program, the icon image displaying means 105 being constituted by a monitor screen, and the subprograms including a plurality of data processing subprograms and a plurality of data reading subprograms, first subprogram storing step of storing the data processing subprograms, each of the data processing subprograms being divided into plurality of short-subprograms, the short-subprograms including a preceding short-subprogram and a following short-subprogram to be performed after the preceding short-subprogram is to be performed, each of the preceding short-subprogram and the following short-subprogram being performed in at least one processing state, digital sound data storing step of storing the digital sound data, and second subprogram storing step of storing the data reading subprogram, each of the data reading subprograms being to be performed in at least one reading stage to read the digital sound data stored by the digital sound data storing means 116, subprogram inserting step S306 of inserting the reading subprogram between the preceding short-subprogram and the following short-subprogram on the basis of the block diagram indicative of the digital sound signal processing subprogram displayed by the icon image displaying means 105, first subprogram judging step S305 of judging whether or not the subprogram inserting means 318 is operative to insert the reading subprogram between the preceding short-subprogram and the following short-subprogram on the basis of the block diagram indicative of the digital sound signal processing subprogram displayed by the icon image displaying means 105, the data processing subprograms inserted by the subprogram inserting means 318 including a preceding subprogram and a following subprogram to be performed after the preceding subprogram is to be performed, each of the preceding subprogram and the following subprogram being performed in at least one processing state, subprogram linking step S125 of linking the preceding subprogram with the following subprogram on the basis of the block diagram indicative of the digital sound signal processing subprogram displayed by the icon image displaying means 105, second subprogram judging step S330 of judging whether or not the subprogram linking means 125 is operative to link the preceding subprogram with the following subprogram on the basis of the block diagram indicative of the digital sound signal processing subprogram displayed by the icon image displaying means 105, executable program producing step S335 of producing a targeted executable program from the subprograms linked by the subprogram linking means 125, and executable program executing step S350 of executing the targeted executable program stored by the executable program storing means 140, the executable program executing means 350 being operative to execute the executable program to process the digital sound data in the processing stage of the preceding short-subprogram of the preceding subprogram before the executable program executing means 350 is operative to execute the executable program to read the digital sound data stored by the digital sound data storing means 116 in the reading stage of the reading subprogram, the executable program executing means 350 being operative to execute the executable program to process both the digital sound data processed in the processing stage of the preceding short-subprogram of the preceding subprogram and the digital sound data read in the reading stage of the reading subprogram in the processing stage of the following short-subprogram of the preceding subprogram after the executable program executing means 350 is operative to execute the executable program to read the digital sound data stored by the digital sound data storing means 116 in the processing stage of the preceding short-subprogram of the preceding subprogram.

The digital audio signal processing system is constituted by the digital sound processing program executing apparatus 300 according to the present invention. The digital audio signal processing system, as will be seen from the above, comprises icon image displaying means 105 for displaying each of the icon images indicative of the subprograms of the digital sound processing program, the icon image displaying means 105 being constituted by a monitor screen, and the subprograms including a plurality of data processing subprograms and a plurality of data reading subprograms, first subprogram storing means 315 for storing the data processing subprograms, each of the data processing subprograms being divided into plurality of short-subprograms, the short-subprograms including a preceding short-subprogram and a following short-subprogram to be performed after the preceding short-subprogram is to be performed, each of the preceding short-subprogram and the following short-subprogram being performed in at least one processing state, digital sound data storing means 116 for storing the digital sound data, second subprogram storing means 117 for storing the data reading subprogram, each of the data reading subprograms being to be performed in at least one reading stage to read the digital sound data stored by the digital sound data storing means 116, subprogram inserting means 318 for inserting the reading subprogram between the preceding short-subprogram and the following short-subprogram on the basis of the block diagram indicative of the digital sound signal processing subprogram displayed by the icon image displaying means 105, first subprogram judging means 319 for judging whether or not the subprogram inserting means 318 is operative to insert the reading subprogram between the preceding short-subprogram and the following short-subprogram on the basis of the block diagram indicative of the digital sound signal processing subprogram displayed by the icon image displaying means 105, the data processing subprograms inserted by the subprogram inserting means 318 including a preceding subprogram and a following subprogram to be performed after the preceding subprogram is to be performed, each of the preceding subprogram and the following subprogram being performed in at least one processing state, subprogram linking means 125 for linking the preceding subprogram with the following subprogram on the basis of the block diagram indicative of the digital sound signal processing subprogram displayed by the icon image displaying means 105, second subprogram judging means 330 for judging whether or not the subprogram linking means 125 is operative to link the preceding subprogram with the following subprogram on the basis of the block diagram indicative of the digital sound signal processing subprogram displayed by the icon image displaying means 105, executable program producing means 335 for producing a targeted executable program from the subprograms linked by the subprogram linking means 125, and executable program executing means 350 for executing the targeted executable program stored by the executable program storing means 140, the executable program executing means 350 being operative to execute the executable program to process the digital sound data in the processing stage of the preceding short-subprogram of the preceding subprogram before the executable program executing means 350 is operative to execute the executable program to read the digital sound data stored by the digital sound data storing means 116 in the reading stage of the reading subprogram, the executable program executing means 350 being operative to execute the executable program to process both the digital sound data processed in the processing stage of the preceding short-subprogram of the preceding subprogram and the digital sound data read in the reading stage of the reading subprogram in the processing stage of the following short-subprogram of the preceding subprogram after the executable program executing means 350 is operative to execute the executable program to read the digital sound data stored by the digital sound data storing means 116 in the processing stage of the preceding short-subprogram of the preceding subprogram.

From the above detailed description, it will be understood that the digital sound processing program executing apparatus 300 can ensure the interface between the preceding subprogram and the following subprogram on the basis of the digital sound processing program requested by an operator so that the following subprogram is performed to receive the digital sound data in the reading stage after the preceding subprogram performs to discharge the digital sound data in the writing stage. As will be seen from the foregoing description, the digital sound processing program executing apparatus according to the present invention can provide an digital sound processing program executing apparatus which can ensure that each of the following subprograms is performed to receive the digital sound data through the reading subprogram performed to read the digital sound data stored by the memory in the reading stage after the preceding subprogram is performed to discharge the digital sound data in the writing stage.

What is claimed is:

1. A digital sound processing program executing apparatus for executing a digital sound processing program after producing said digital sound processing program from a plurality of subprograms, each of said subprograms being associated with an icon image, comprising:
icon image displaying means for displaying each of said icon images indicative of said subprograms of said digital sound processing program, said icon image displaying means being constituted by a monitor screen, and said subprograms including a plurality of data processing subprograms and a plurality of data reading subprograms;
first subprogram storing means for storing said data processing subprograms, said data processing subprograms including a preceding subprogram and a plurality of following subprograms to be performed after said preceding subprogram is to be performed, said preceding subprogram being to be performed in at least one writing stage after said preceding subprogram is to be performed in at least one processing stage, and each of said following subprograms being to be performed in at least one processing stage, and said icon images including a first icon image indicative of said preceding subprogram and a second icon image indicative of each of said following subprograms;
digital sound data storing means for storing said digital sound data;
second subprogram storing means for storing said data reading subprogram, each of said data reading subprograms being to be performed in at least one reading stage to read said digital sound data stored by said digital sound data storing means;
subprogram classifying means for classifying each of said preceding subprogram and said following subprograms on the basis of said block diagram indicative of said digital sound processing program displayed by said icon image displaying means;
subprogram linking means for linking said preceding subprogram with each of said following subprograms on the basis of said block diagram indicative of said digital sound processing program displayed by said icon image displaying means;
subprogram judging means for judging whether or not said subprogram linking means is operative to link said preceding subprogram with each of said following subprograms through said reading subprogram on the basis of said block diagram indicative of said digital sound signal processing subprogram displayed by said icon image displaying means;
executable program producing means for producing a targeted executable program from said subprograms linked by said subprogram linking means; and
executable program executing means for executing said targeted executable program produced by said executable program producing means, said executable program executing means being operative to execute said executable program in said writing stage of each of said preceding subprograms to write said digital sound data into said digital sound data storing means after said executable program executing means is operative to execute said executable program in said processing stage of each of said preceding subprograms to process said digital sound data, and said executable program executing means being operative to execute said executable program in said reading stage of each of said reading subprograms to read said digital sound data stored by said digital sound data storing means before said executable program executing means is operative to execute said executable program in said processing stage of said following subprogram to process said digital sound data. .

2. A digital sound processing program executing apparatus for executing a digital sound processing program after producing said digital sound processing program from a plurality of subprograms, each of said subprograms being associated with an icon image, comprising:
icon image displaying means for displaying each of said icon images indicative of said subprograms of said digital sound processing program, said icon image displaying means being constituted by a monitor screen, and said subprograms including a plurality of data processing subprograms and a plurality of data reading subprograms;
first subprogram storing means for storing said data processing subprograms, said data processing subprograms including a preceding subprogram and a plurality of following subprograms to be performed after said preceding subprogram is to be performed, said preceding subprogram being to be performed in at least one writing stage after said preceding subprogram is to be performed in at least one processing stage, and each of said following subprograms being to be performed in at least one processing stage, and said icon images including a first icon image indicative of said preceding subprogram and a second icon image indicative of each of said following subprograms;
digital sound data storing means for storing said digital sound data;
second subprogram storing means for storing said data reading subprogram, each of said data reading subprograms being to be performed in at least one reading stage to read said digital sound data stored by said digital sound data storing means;
subprogram classifying means for classifying each of said preceding subprogram and said following subprograms on the basis of said block diagram indicative of said digital sound processing program displayed by said icon image displaying means;
subprogram linking means for linking said preceding subprogram with each of said following subprograms on the basis of said block diagram indicative of said digital sound processing program displayed by said icon image displaying means;
subprogram judging means for judging whether or not said subprogram linking means is operative to link said preceding subprogram with each of said following subprograms through said reading subprogram on the basis of said block diagram indicative of said digital sound signal processing subprogram displayed by said icon image displaying means;
executable program producing means for producing a plurality of targeted executable program from said subprograms linked by said subprogram linking means, said targeted executable program including a first executable program and a second executable program, said first executable program being to be performed in each of said processing stage and said writing stage of said preceding subprogram, and said second executable program being to be performed in said reading stage of said reading subprogram and in each of said processing stages of said following subprogram; and
a plurality of executable program executing means for executing said targeted executable program produced by said executable program producing means, said executable program executing means having a first executable program executing means and a second executable program executing means, said first executable program executing means being operative to execute said first executable program to process said digital sound data in said processing stage of said preceding subprogram before said first executable program executing means is operative to execute said first executable program to write said digital sound data processed in said processing stage into said digital sound data storing means, and said second executable program executing means being operative to execute said second executable program to read said digital sound data stored by said digital sound data storing means in said reading stage of said reading subprogram before said second executable program executing means is operative to execute said second executable program to process said digital sound data read in said reading stage of said reading subprogram in each of said processing stages of said following subprogram.

3. A digital sound processing program executing apparatus for executing a digital sound processing program after producing said digital sound processing program from a plurality of subprograms, each of said subprograms being associated with an icon image, comprising:
icon image displaying means for displaying each of said icon images indicative of said subprograms of said digital sound processing program, said icon image displaying means being constituted by a monitor screen, and said subprograms including a plurality of data processing subprograms and a plurality of data reading subprograms;
first subprogram storing means for storing said data processing subprograms, each of said data processing subprograms being divided into plurality of short-subprograms, said short-subprograms including a preceding short-subprogram and a following short-subprogram to be performed after said preceding short-subprogram is to be performed, each of said preceding short-subprogram and said following short-subprogram being performed in at least one processing state,
digital sound data storing means for storing said digital sound data;
second subprogram storing means for storing said data reading subprogram, each of said data reading subprograms being to be performed in at least one reading stage to read said digital sound data stored by said digital sound data storing means;
subprogram inserting means for inserting said reading subprogram between said preceding short-subprogram and said following short-subprogram on the basis of said block diagram indicative of said digital sound signal processing subprogram displayed by said icon image displaying means;
first subprogram judging means for judging whether or not said subprogram inserting means is operative to insert said reading subprogram between said preceding short-subprogram and said following short-subprogram on the basis of said block diagram indicative of said digital sound signal processing subprogram displayed by said icon image displaying means, said data processing subprograms inserted by said subprogram inserting means including a preceding subprogram and a following subprogram to be performed after said preceding subprogram is to be performed, each of said preceding subprogram and said following subprogram being performed in at least one processing state,
subprogram linking means for linking said preceding subprogram with said following subprogram on the basis of said block diagram indicative of said digital sound signal processing subprogram displayed by said icon image displaying means;
second subprogram judging means for judging whether or not said subprogram linking means is operative to link said preceding subprogram with said following subprogram on the basis of said block diagram indicative of said digital sound signal processing subprogram displayed by said icon image displaying means;
executable program producing means for producing a targeted executable program from said subprograms linked by said subprogram linking means;
executable program executing means for executing said targeted executable program stored by said executable program storing means, said executable program executing means being operative to execute said executable program to process said digital sound data in said processing stage of said preceding short-subprogram of said preceding subprogram before said executable program executing means is operative to execute said executable program to read said digital sound data stored by said digital sound data storing means in said reading stage of said reading subprogram, said executable program executing means being operative to execute said executable program to process both said digital sound data processed in said processing stage of said preceding short-subprogram of said preceding subprogram and said digital sound data read in said reading stage of said reading subprogram in said processing stage of said following short-subprogram of said preceding subprogram after said executable program executing means is operative to execute said executable program to read said digital sound data stored by said digital sound data storing means in said processing stage of said preceding short-subprogram of said preceding subprogram.

4. A digital sound processing program executing apparatus for executing a digital sound processing program after producing said digital sound processing program from a plurality of subprograms, each of said subprograms being associated with an icon image, comprising:
icon image displaying means for displaying said icon images indicative of said subprograms of said digital sound processing program, said icon image displaying means being constituted by a monitor screen, said subprograms including a preceding subprogram and at least one following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram, said subprograms further including a reading subprogram to be performed in a reading stage;
icon image connecting means for connecting said first icon image with said second icon image to allow said icon image displaying means to show said digital sound processing program;
subprogram storing means for storing said subprograms;
subprogram transferring means for transferring said subprograms out of said subprogram storing means;
subprogram linking means for linking said preceding subprogram with said following subprogram through said reading subprogram on the basis of said digital sound processing program displayed by said icon image displaying means;
subprogram judging means for judging whether or not said subprogram linking means is operative to link said preceding subprogram with said following subprogram through said reading subprogram on the basis of said digital sound processing program displayed by said icon image displaying means;
executable program producing means for producing a targeted executable program from said subprograms linked by said subprogram linking means;
executable program storing means for storing said targeted executable program;
executable program transferring means for transferring said targeted executable program into said executable program storing means; and
executable program executing means for executing said targeted executable program stored by said executable program storing means.

5. A digital sound processing program executing apparatus for executing a digital sound processing program after producing said digital sound processing program from a plurality of subprograms, each of said subprograms being associated with an icon image, comprising:
icon image displaying means for displaying said icon images indicative of said subprograms of said digital sound processing program, said icon image displaying means being constituted by a monitor screen, said subprograms including a preceding subprogram and a plurality of following subprograms to be performed after said preceding subprogram is to be performed, each of said preceding subprogram and said following subprograms being to be performed in a processing stage, said icon images including a first icon image indicative of said preceding subprogram and a plurality of second icon images indicative of said following subprograms, said subprograms further including a reading subprogram to be performed in a reading stage;
icon image connecting means for connecting said first icon image with each of said second icon images to allow said icon image displaying means to show said digital sound processing program;
subprogram storing means for storing said subprograms;
subprogram transferring means for transferring said subprograms out of said subprogram storing means;
subprogram linking means for linking said preceding subprogram with each of said following subprograms through said reading subprogram on the basis of said digital sound processing program displayed by said icon image displaying means;
subprogram judging means for judging whether or not said subprogram linking means is operative to link said preceding subprogram with each of said following subprograms through said reading subprogram on the basis of said digital sound processing program displayed by said icon image displaying means;
executable program producing means for producing a targeted executable program from said subprograms linked by said subprogram linking means;
executable program storing means for storing said targeted executable program;
executable program transferring means for transferring said targeted executable program into said executable program storing means; and
executable program executing means for executing said targeted executable program stored by said executable program storing means.

6. A digital sound processing program executing apparatus for executing a digital sound processing program after producing said digital sound processing program from a plurality of subprograms, each of said subprograms being associated with an icon image, comprising:
icon image displaying means for displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram said subprograms further including a reading subprogram to be performed in a reading stage;
icon image connecting means for connecting said first icon image with said second icon image to allow said icon image displaying means to show said digital sound processing program;
subprogram storing means for storing said subprograms;
subprogram transferring means for transferring said subprograms out of said subprogram storing means;
subprogram linking means for linking said preceding subprogram with said following subprogram through said reading subprogram on the basis of said digital sound processing program displayed by said icon image displaying means;
subprogram judging means for judging whether or not said subprogram linking means is operative to link said preceding subprogram with said following subprogram through said reading subprogram on the basis of said digital sound processing program displayed by said icon image displaying means;
executable program producing means for producing a plurality of targeted executable programs from said subprograms linked by said subprogram linking means;
a plurality of executable program storing means for respectively storing said targeted executable programs;
executable program transferring means for transferring each of said targeted executable programs into each of said executable program storing means; and
a plurality of executable program executing means for respectively executing said targeted executable programs stored by said executable program storing means.

7. A digital sound processing program executing apparatus for executing a digital sound processing program after producing said digital sound processing program from a plurality of subprograms, each of said subprograms being associated with an icon image, comprising:
icon image displaying means for displaying said icon images indicative of said subprograms of said digital sound processing program, said icon image displaying means being constituted by a monitor screen, said subprograms including a preceding subprogram and a plurality of following subprograms to be performed after said preceding subprogram is to be performed, each of said preceding subprogram and said following subprograms being to be performed in a processing stage, said icon images including a first icon image indicative of said preceding subprogram and a plurality of second icon images indicative of said following subprograms said subprograms further including a reading subprogram to be performed in a reading stage;
icon image connecting means for connecting said first icon image with each of said second icon images to allow said icon image displaying means to show said digital sound processing program;
subprogram storing means for storing said subprograms;
subprogram transferring means for transferring said subprograms out of said subprogram storing means;
subprogram linking means for linking said preceding subprogram with each of said following subprograms through said reading subprogram on the basis of said digital sound processing program displayed by said icon image displaying means;
subprogram judging means for judging whether or not said subprogram linking means is operative to link said preceding subprogram with each of said following subprograms through said reading subprogram on the basis of said digital sound processing program displayed by said icon image displaying means;
executable program producing means for producing a plurality of targeted executable programs from said subprograms linked by said subprogram linking means;
a plurality of executable program storing means for storing said targeted executable programs;
executable program transferring means for transferring each of said targeted executable programs into each of said executable program storing means; and
a plurality of executable program executing means for executing said targeted executable programs stored by said executable program storing means.

8. A digital sound processing program executing apparatus for executing a digital sound processing program after producing said digital sound processing program from a plurality of subprograms, each of said subprograms being associated with an icon image, comprising:
icon image displaying means for displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram, said subprograms further including a reading subprogram to be performed in a reading stage, each of said preceding subprogram and said following subprogram including at least one dividable subprogram to be performed in a processing state, said dividable subprogram including a preceding short-subprogram and a following short-subprogram to be performed after said preceding short-subprogram is to be performed, each of said preceding short-subprogram and said following short-subprogram being to be performed in a processing stage;
subprogram dividing means for dividing said dividable subprogram into said preceding short-subprogram and said following short-subprogram;
icon image connecting means for connecting said first icon image with said second icon image to allow said icon image displaying means to show said digital sound processing program;
subprogram storing means for storing said subprograms;
subprogram transferring means for transferring said subprograms out of said subprogram storing means;
dividable subprogram judging means for judging whether or not said subprogram dividing means is operative to divide said dividable subprograms into said preceding short-subprogram and said following short-subprogram on the basis of said digital sound processing program displayed by said icon image displaying means;
subprogram linking means for linking said preceding short-subprogram with said following short-subprogram through said reading subprogram after said subprogram dividing means is operative to divide said dividable subprogram into said preceding short-subprogram with said following short-subprogram, and linking said preceding subprogram with said following subprogram on the basis of said digital sound processing program displayed by said icon image displaying means;
subprogram judging means for judging whether or not said subprogram linking means is operative to link said preceding subprogram with said following subprogram on the basis of said digital sound processing program displayed by said icon image displaying means;
executable program producing means for producing a targeted executable program from said subprograms linked by said subprogram linking means;
executable program storing means for storing said targeted executable program;
executable program transferring means for transferring said targeted executable program into said executable program storing means; and
executable program executing means for executing said targeted executable program stored by said executable program storing means.

9. A digital sound processing program executing apparatus as set forth in claims 4 to 7, in which
said subprogram linking means is operative to link said preceding subprogram with each of said following subprograms through said reading subprogram on the basis of said digital sound processing program displayed by said icon image displaying means when said subprogram judging means is operative to judge as said subprogram linking means is operative to link said preceding subprogram with each of said following subprograms through said reading subprogram on the basis of said subprogram linked by said subprogram linking means; and
said subprogram linking means is operative to link directly said preceding subprogram with each of said following subprograms on the basis of said digital sound processing program displayed by said icon image displaying means when said subprogram judging means is operative to judge as said subprogram linking means is operative to link directly said preceding subprogram with each of said following subprograms on the basis of said digital sound processing program displayed by said icon image displaying means.

10. A digital sound processing program executing apparatus as set forth in claims 4 and 5, which further comprises
digital sound data storing means for storing said digital sound data, said preceding subprogram being to be further performed in a writing stage after said preceding subprogram is to be performed in said processing stage; and in which
said executable program executing means is operative to execute said targeted executable program stored by said executable program storing means to process said digital sound data in said processing stage of said preceding subprogram before said executable program executing means is operative to execute said targeted executable program stored by said executable program storing means to write said digital sound data processed in said processing stage of said preceding subprogram into said digital sound data storing means in said reading stage of said reading subprogram, and
said executable program executing means is operative to execute said targeted executable program stored by said executable program storing means to read said digital sound data stored by said digital sound data storing means in said reading stage of said reading subprogram before said executable program executing means is operative to execute said targeted executable program stored by said executable program storing means to process said digital sound data in said following processing stage of each of said following subprograms.

11. A digital sound processing program executing apparatus as set forth in claims 1 to 8, which further comprises
subprogram selecting means for selecting at least two subprograms from among said subprograms stored by said subprogram storing means to allow said icon image displaying means to display said icon images on said monitor screen on the basis of said digital sound processing program; and in which
said subprogram selecting means is operative to select each of said subprograms while said icon image displaying means is operative to display said icon image of each of said subprograms selected by said subprogram selecting means.

12. A digital sound processing program executing method of executing a digital sound processing program after producing said digital sound processing program from a plurality of subprograms, each of said subprograms being associated with an icon image, comprising:
a preparing step of preparing:
icon image displaying means for displaying each of said icon images indicative of said subprograms of said digital sound, processing program, said icon image displaying means being constituted by a monitor screen, and said subprograms including a plurality of data processing subprograms and a plurality of data reading subprograms;
first subprogram storing means for storing said data processing subprograms, said data processing subprograms including a preceding subprogram and a plurality of following subprograms to be performed after said preceding subprogram is to be performed, said preceding subprogram being to be performed in at least one writing stage after said preceding subprogram is to be performed in at least one processing stage, and each of said following subprograms being to be performed in at least one processing stage, and said icon images including a first icon image indicative of said preceding subprogram and a second icon image indicative of each of said following subprograms;
digital sound data storing means for storing said digital sound data;
second subprogram storing means for storing said data reading subprogram, each of said data reading subprograms being to be performed in at least one reading stage to read said digital sound data stored by said digital sound data storing means;
subprogram classifying means for classifying each of said preceding subprogram and said following subprograms on the basis of said block diagram indicative of said digital sound processing program displayed by said icon image displaying means;
subprogram linking means for linking said preceding subprogram with each of said following subprograms on the basis of said block diagram indicative of said digital sound processing program displayed by said icon image displaying means;
subprogram judging means for judging whether or not said subprogram linking means is operative to link said preceding subprogram with each of said following subprograms through said reading subprogram on the basis of said block diagram indicative of said digital sound signal processing subprogram displayed by said icon image displaying means;
executable program producing means for producing a targeted executable program from said subprograms linked by said subprogram linking means; and
executable program executing means for executing said targeted executable program produced by said executable program producing means, said executable program executing means being operative to execute said executable program in said writing stage of each of said preceding subprograms to write said digital sound data into said digital sound data storing means after said executable program executing means is operative to execute said executable program in said processing stage of each of said preceding subprograms to process said digital sound data, and said executable program executing means being operative to execute said executable program in said reading stage of each of said reading subprograms to read said digital sound data stored by said digital sound data storing means before said executable program executing means is operative to execute said executable program in said processing stage of said following subprogram to process said digital sound data, and
icon image displaying step of displaying each of said icon images indicative of said subprograms of said digital sound processing program, said icon image displaying means being constituted by a monitor screen, and said subprograms including a plurality of data processing subprograms and a plurality of data reading subprograms;
first subprogram storing step of storing said data processing subprograms, said data processing subprograms including a preceding subprogram and a plurality of following subprograms to be performed after said preceding subprogram is to be performed, said preceding subprogram being to be performed in at least one writing stage after said preceding subprogram is to be performed in at least one processing stage, and each of said following subprograms being to be performed in at least one processing stage, and said icon images including a first icon image indicative of said preceding subprogram and a second icon image indicative of each of said following subprograms;
digital sound data storing step of storing said digital sound data;
second subprogram storing step of storing said data reading subprogram, each of said data reading subprograms being to be performed in at least one reading stage to read said digital sound data stored by said digital sound data storing means;
subprogram classifying step of classifying each of said preceding subprogram and said following subprograms on the basis of said block diagram indicative of said digital sound processing program displayed by said icon image displaying means;
subprogram linking step of linking said preceding subprogram with each of said following subprograms on the basis of said block diagram indicative of said digital sound processing program displayed by said icon image displaying means;
subprogram judging step of judging whether or not said subprogram linking means is operative to link said preceding subprogram with each of said following subprograms through said reading subprogram on the basis of said block diagram indicative of said digital sound signal processing subprogram displayed by said icon image displaying means;
executable program producing step of producing a targeted executable program from said subprograms linked by said subprogram linking means; and
executable program executing step of executing said targeted executable program produced by said executable program producing means, said executable program executing means being operative to execute said executable program in said writing stage of each of said preceding subprograms to write said digital sound data into said digital sound data storing means after said executable program executing means is operative to execute said executable program in said processing stage of each of said preceding subprograms to process said digital sound data, and said executable program executing means being operative to execute said executable program in said reading stage of each of said reading subprograms to read said digital sound data stored by said digital sound data storing means before said executable program executing means is operative to execute said executable program in said processing stage of said following subprogram to process said digital sound data.

13. A digital sound processing program executing method of executing a digital sound processing program after producing said digital sound processing program from a plurality of subprograms, each of said subprograms being associated with an icon image, comprising:
a preparing step of preparing:
icon image displaying means for displaying each of said icon images indicative of said subprograms of said digital sound processing program, said icon image displaying means being constituted by a monitor screen, and said subprograms including a plurality of data processing subprograms and a plurality of data reading subprograms;
first subprogram storing means for storing said data processing subprograms, said data processing subprograms including a preceding subprogram and a plurality of following subprograms to be performed after said preceding subprogram is to be performed, said preceding subprogram being to be performed in at least one writing stage after said preceding subprogram is to be performed in at least one processing stage, and each of said following subprograms being to be performed in at least one processing stage, and said icon images including a first icon image indicative of said preceding subprogram and a second icon image indicative of each of said following subprograms;
digital sound data storing means for storing said digital sound data;
second subprogram storing means for storing said data reading subprogram, each of said data reading subprograms being to be performed in at least one reading stage to read said digital sound data stored by said digital sound data storing means;
subprogram classifying means for classifying each of said preceding subprogram and said following subprograms on the basis of said block diagram indicative of said digital sound processing program displayed by said icon image displaying means;
subprogram linking means for linking said preceding subprogram with each of said following subprograms on the basis of said block diagram indicative of said digital sound processing program displayed by said icon image displaying means;
subprogram judging means for judging whether or not said subprogram linking means is operative to link said preceding subprogram with each of said following subprograms through said reading subprogram on the basis of said block diagram indicative of said digital sound signal processing subprogram displayed by said icon image displaying means;
executable program producing means for producing a plurality of targeted executable program from said subprograms linked by said subprogram linking means, said targeted executable program including a first executable program and a second executable program, said first executable program being to be performed in each of said processing stage and said writing stage of said preceding subprogram, and said second executable program being to be performed in said reading stage of said reading subprogram and in each of said processing stages of said following subprogram; and
a plurality of executable program executing means for executing said targeted executable program produced by said executable program producing means, said executable program executing means having a first executable program executing means and a second executable program executing means, said first executable program executing means being operative to execute said first executable program to process said digital sound data in said processing stage of said preceding subprogram before said first executable program executing means is operative to execute said first executable program to write said digital sound data processed in said processing stage into said digital sound data storing means, and said second executable program executing means being operative to execute said second executable program to read said digital sound data stored by said digital sound data storing means in said reading stage of said reading subprogram before said second executable program executing means is operative to execute said second executable program to process said digital sound data read in said reading stage of said reading subprogram in each of said processing stages of said following subprogram, and
icon image displaying step of displaying each of said icon images indicative of said subprograms of said digital sound processing program, said icon image displaying means being constituted by a monitor screen, and said subprograms including a plurality of data processing subprograms and a plurality of data reading subprograms;
first subprogram storing step of storing said data processing subprograms, said data processing subprograms including a preceding subprogram and a plurality of following subprograms to be performed after said preceding subprogram is to be performed, said preceding subprogram being to be performed in at least one writing stage after said preceding subprogram is to be performed in at least one processing stage, and each of said following subprograms being to be performed in at least one processing stage, and said icon images including a first icon image indicative of said preceding subprogram and a second icon image indicative of each of said following subprograms;
digital sound data storing step of storing said digital sound data;
second subprogram storing step of storing said data reading subprogram, each of said data reading subprograms being to be performed in at least one reading stage to read said digital sound data stored by said digital sound data storing means;
subprogram classifying step of classifying each of said preceding subprogram and said following subprograms on the basis of said block diagram indicative of said digital sound processing program displayed by said icon image displaying means;
subprogram linking step of linking said preceding subprogram with each of said following subprograms on the basis of said block diagram indicative of said digital sound processing program displayed by said icon image displaying means;
subprogram judging step of judging whether or not said subprogram linking means is operative to link said preceding subprogram with each of said following subprograms through said reading subprogram on the basis of said block diagram indicative of said digital sound signal processing subprogram displayed by said icon image displaying means;
executable program producing step of producing a plurality of targeted executable program from said subprograms linked by said subprogram linking means, said targeted executable program including a first executable program and a second executable program, said first executable program being to be performed in each of said processing stage and said writing stage of said preceding subprogram, and said second executable program being to be performed in said reading stage of said reading subprogram and in each of said processing stages of said following subprogram; and
a plurality of executable program executing step of executing said targeted executable program produced by said executable program producing means, said executable program executing means having a first executable program executing means and a second executable program executing means, said first executable program executing means being operative to execute said first executable program to process said digital sound data in said processing stage of said preceding subprogram before said first executable program executing means is operative to execute said first executable program to write said digital sound data processed in said processing stage into said digital sound data storing means, and said second executable program executing means being operative to execute said second executable program to read said digital sound data stored by said digital sound data storing means in said reading stage of said reading subprogram before said second executable program executing means is operative to execute said second executable program to process said digital sound data read in said reading stage of said reading subprogram in each of said processing stages of said following subprogram.

14. A digital sound processing program executing method of executing a digital sound processing program after producing said digital sound processing program from a plurality of subprograms, each of said subprograms being associated with an icon image, comprising:
a preparing step of preparing:
icon image displaying means for displaying each of said icon images indicative of said subprograms of said digital sound processing program, said icon image displaying means being constituted by a monitor screen, and said subprograms including a plurality of data processing subprograms and a plurality of data reading subprograms;
first subprogram storing means for storing said data processing subprograms, each of said data processing subprograms being divided into plurality of short-subprograms, said short-subprograms including a preceding short-subprogram and a following short-subprogram to be performed after said preceding short-subprogram is to be performed, each of said preceding short-subprogram and said following short-subprogram being performed in at least one processing state,
digital sound data storing means for storing said digital sound data;
second subprogram storing means for storing said data reading subprogram, each of said data reading subprograms being to be performed in at least one reading stage to read said digital sound data stored by said digital sound data storing means;
subprogram inserting means for inserting said reading subprogram between said preceding short-subprogram and said following short-subprogram on the basis of said block diagram indicative of said digital sound signal processing subprogram displayed by said icon image displaying means;
first subprogram judging means for judging whether or not said subprogram inserting means is operative to insert said reading subprogram between said preceding short-subprogram and said following short-subprogram on the basis of said block diagram indicative of said digital sound signal processing subprogram displayed by said icon image displaying means, said data processing subprograms inserted by said subprogram inserting means including a preceding subprogram and a following subprogram to be performed after said preceding subprogram is to be performed, each of said preceding subprogram and said following subprogram being performed in at least one processing state,
subprogram linking means for linking said preceding subprogram with said following subprogram on the basis of said block diagram indicative of said digital sound signal processing subprogram displayed by said icon image displaying means;
second subprogram judging means for judging whether or not said subprogram linking means is operative to link said preceding subprogram with said following subprogram on the basis of said block diagram indicative of said digital sound signal processing subprogram displayed by said icon image displaying means;
executable program producing means for producing a targeted executable program from said subprograms linked by said subprogram linking means; executable program executing means for executing said targeted executable program stored by said executable program storing means, said executable program executing means being operative to execute said executable program to process said digital sound data in said processing stage of said preceding short-subprogram of said preceding subprogram before said executable program executing means is operative to execute said executable program to read said digital sound data stored by said digital sound data storing means in said reading stage of said reading subprogram, said executable program executing means being operative to execute said executable program to process both said digital sound data processed in said processing stage of said preceding short-subprogram of said preceding subprogram and said digital sound data read in said reading stage of said reading subprogram in said processing stage of said following short-subprogram of said preceding subprogram after said executable program executing means is operative to execute said executable program to read said digital sound data stored by said digital sound data storing means in said processing stage of said preceding short-subprogram of said preceding subprogram, and
icon image displaying step of displaying each of said icon images indicative of said subprograms of said digital sound processing program, said icon image displaying means being constituted by a monitor screen, and said subprograms including a plurality of data processing subprograms and a plurality of data reading subprograms;
first subprogram storing step of storing said data processing subprograms, each of said data processing subprograms being divided into plurality of short-subprograms, said short-subprograms including a preceding short-subprogram and a following short-subprogram to be performed after said preceding short-subprogram is to be performed, each of said preceding short-subprogram and said following short-subprogram being performed in at least one processing state,
digital sound data storing step of storing said digital sound data;
second subprogram storing step of storing said data reading subprogram, each of said data reading subprograms being to be performed in at least one reading stage to read said digital sound data stored by said digital sound data storing means;
subprogram inserting step of inserting said reading subprogram between said preceding short-subprogram and said following short-subprogram on the basis of said block diagram indicative of said digital sound signal processing subprogram displayed by said icon image displaying means;
first subprogram judging step of judging whether or not said subprogram inserting means is operative to insert said reading subprogram between said preceding -short-subprogram and said following short-subprogram on the basis of said block diagram indicative of said digital sound signal processing subprogram displayed by said icon image displaying means, said data processing subprograms inserted by said subprogram inserting means including a preceding subprogram and a following subprogram to be performed after said preceding subprogram is to be performed, each of said preceding subprogram and said following subprogram being performed in at least one processing state,
subprogram linking step of linking said preceding subprogram with said following subprogram on the basis of said block diagram indicative of said digital sound signal processing subprogram displayed by said icon image displaying means;
second subprogram judging step of judging whether or not said subprogram linking means is operative to link said preceding subprogram with said following subprogram on the basis of said block diagram indicative of said digital sound signal processing subprogram displayed by said icon image displaying means;
executable program producing step of producing a targeted executable program from said subprograms linked by said subprogram linking means;
executable program executing step of executing said targeted executable program stored by said executable program storing means, said executable program executing step being operative to execute said executable program to process said digital sound data in said processing stage of said preceding short-subprogram of said preceding subprogram before said executable program executing means is operative to execute said executable program to read said digital sound data stored by said digital sound data storing step in said reading stage of said reading subprogram, said executable program executing means being operative to execute said executable program to process both said digital sound data processed in said processing stage of said preceding short-subprogram of said preceding subprogram and said digital sound data read in said reading stage of said reading subprogram in said processing stage of said following short-subprogram of said preceding subprogram after said executable program executing means is operative to execute said executable program to read said digital sound data stored by said digital sound data storing means in said processing stage of said preceding short-subprogram of said preceding subprogram.

15. A digital sound processing program executing method of executing a digital sound processing program after producing said digital sound processing program from a plurality of subprograms, each of said subprograms being associated with a icon image, comprising:
a preparing step of preparing:
icon image displaying means for displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram, said subprograms further including a reading subprogram to be performed in a reading stage;
icon image connecting means for connecting said first icon image with said second icon image to allow said icon image displaying means to show said digital sound processing program;
subprogram storing means for storing said subprograms;
subprogram transferring means for transferring said subprograms out of said subprogram storing means;
subprogram linking means for linking said preceding subprogram with said following subprogram through said reading subprogram on the basis of said digital sound processing program displayed by said icon image displaying means;
subprogram judging means for judging whether or not said subprogram linking means is operative to link said preceding subprogram with said following subprogram through said reading subprogram on the basis of said digital sound processing program displayed by said icon image displaying means;
executable program producing means for producing a targeted executable program from said subprograms linked by said subprogram linking means;
executable program storing means for storing said targeted executable program;
executable program transferring means for transferring said targeted executable program into said executable program storing means; and
executable program executing means for executing said targeted executable program stored by said executable program storing means; and
icon image displaying step of displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram, said subprograms further including a reading subprogram to be performed in a reading stage;
icon image connecting step of connecting said first icon image with said second icon image to allow said icon image displaying means to show said digital sound processing program;
subprogram storing step of storing said subprograms;
subprogram transferring step of transferring said subprograms out of said subprogram storing means;
subprogram linking step of linking said preceding subprogram with said following subprogram through said reading subprogram on the basis of said digital sound processing program displayed by said icon image displaying means;
subprogram judging step of judging whether or not said subprogram linking means is operative to link said preceding subprogram with said following subprogram through said reading subprogram on the basis of said digital sound processing program displayed by said icon image displaying means;
executable program producing step of producing a targeted executable program from said subprograms linked by said subprogram linking means;
executable program storing step of storing said targeted executable program;
executable program transferring step of transferring said targeted executable program into said executable program storing means; and
executable program executing step of executing said targeted executable program stored by said executable program storing means.

16. A digital sound processing program executing method of executing a digital sound processing program after producing said digital sound processing program from a plurality of subprograms, each of said subprograms being associated with a icon image, comprising:
a preparing step of preparing:
icon image displaying means for displaying said icon images indicative of said subprograms of said digital sound processing program, said icon image displaying means being constituted by a monitor screen, said subprograms including a preceding subprogram and a plurality of following subprograms to be performed after said preceding subprogram is to be performed, each of said preceding subprogram and said following subprograms being to be performed in a processing stage, said icon images including a first icon image indicative of said preceding subprogram and a plurality of second icon images indicative of said following subprograms, said subprograms further including a reading subprogram to be performed in a reading stage;
icon image connecting means for connecting said first icon image with each of said second icon images to allow said icon image displaying means to show said digital sound processing program;
subprogram storing means for storing said subprograms;
subprogram transferring means for transferring said subprograms out of said subprogram storing means;
subprogram linking means for linking said preceding subprogram with each of said following subprograms through said reading subprogram on the basis of said digital sound processing program displayed by said icon image displaying means;
subprogram judging means for judging whether or not said subprogram linking means is operative to link said preceding subprogram with each of said following subprograms through said reading subprogram on the basis of said digital sound processing program displayed by said icon image displaying means;
executable program producing means for producing a targeted executable program from said subprograms linked by said subprogram linking means;
executable program storing means for storing said targeted executable program;
executable program transferring means for transferring said targeted executable program into said executable program storing means; and
executable program executing means for executing said targeted executable program stored by said executable program storing means, and
icon image displaying step of displaying said icon images indicative of said subprograms of said digital sound processing program, said icon image displaying means being constituted by a monitor screen, said subprograms including a preceding subprogram and a plurality of following subprograms to be performed after said preceding subprogram is to be performed, each of said preceding subprogram and said following subprograms being to be performed in a processing stage, said icon images including a first icon image indicative of said preceding subprogram and a plurality of second icon images indicative of said following subprograms, said subprograms further including a reading subprogram to be performed in a reading stage;
icon image connecting step of connecting said first icon image with each of said second icon images to allow said icon image displaying means to show said digital sound processing program;
subprogram storing step of storing said subprograms;
subprogram transferring step of transferring said subprograms out of said subprogram storing means;
subprogram linking step of linking said preceding subprogram with each of said following subprograms through said reading subprogram on the basis of said digital sound processing program displayed by said icon image displaying means;
subprogram judging step of judging whether or not said subprogram linking means is operative to link said preceding subprogram with each of said following subprograms through said reading subprogram on the basis of said digital sound processing program displayed by said icon image displaying means;
executable program producing step of producing a targeted executable program from said subprograms linked by said subprogram linking means;
executable program storing step of storing said targeted executable program;
executable program transferring step of transferring said targeted executable program into said executable program storing means; and
executable program executing step of executing said targeted executable program stored by said executable program storing means.

17. A digital sound processing program executing method of executing a digital sound processing program after producing said digital sound processing program from a plurality of subprograms, each of said subprograms being associated with a icon image, comprising:
a preparing step of preparing:
icon image displaying means for displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram said subprograms further including a reading subprogram to be performed in a reading stage;
icon image connecting means for connecting said first icon image with said second icon image to allow said icon image displaying means to show said digital sound processing program;
subprogram storing means for storing said subprograms;
subprogram transferring means for transferring said subprograms out of said subprogram storing means;
subprogram linking means for linking said preceding subprogram with said following subprogram through said reading subprogram on the basis of said digital sound processing program displayed by said icon image displaying means;
subprogram judging means for judging whether or not said subprogram linking means is operative to link said preceding subprogram with said following subprogram through said reading subprogram on the basis of said digital sound processing program displayed by said icon image displaying means;
executable program producing means for producing a plurality of targeted executable programs from said subprograms linked by said subprogram linking means;
a plurality of executable program storing means for respectively storing said targeted executable programs;
executable program transferring means for transferring each of said targeted executable programs into each of said executable program storing means; and
a plurality of executable program executing means for respectively executing said targeted executable programs stored by said executable program storing means;
icon image displaying step of displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram said subprograms further including a reading subprogram to be performed in a reading stage;
icon image connecting step of connecting said first icon image with said second icon image to allow said icon image displaying means to show said digital sound processing program;
subprogram storing step of storing said subprograms;
subprogram transferring step of transferring said subprograms out of said subprogram storing means;
subprogram linking step of linking said preceding subprogram with said following subprogram through said reading subprogram on the basis of said digital sound processing program displayed by said icon image displaying means;
subprogram judging step of judging whether or not said subprogram linking means is operative to link said preceding subprogram with said following subprogram through said reading subprogram on the basis of said digital sound processing program displayed by said icon image displaying means;
executable program producing step of producing a plurality of targeted executable programs from said subprograms linked by said subprogram linking means;
a plurality of executable program storing step of respectively storing said targeted executable programs;
executable program transferring step of transferring each of said targeted executable programs into each of said executable program storing means; and
a plurality of executable program executing step of respectively executing said targeted executable programs stored by said executable program storing means.

18. A digital sound processing program executing method of executing a digital sound processing program after producing said digital sound processing program from a plurality of subprograms, each of said subprograms being associated with a icon image, comprising:
a preparing step of preparing:
icon image displaying means for displaying said icon images indicative of said subprograms of said digital sound processing program, said icon image displaying means being constituted by a monitor screen, said subprograms including a preceding subprogram and a plurality of following subprograms to be performed after said preceding subprogram is to be performed, each of said preceding subprogram and said following subprograms being to be performed in a processing stage, said icon images including a first icon image indicative of said preceding subprogram and a plurality of second icon images indicative of said following subprograms said subprograms further including a reading subprogram to be performed in a reading stage;
icon image connecting means for connecting said first icon image with each of said second icon images to allow said icon image displaying means to show said digital sound processing program;
subprogram storing means for storing said subprograms;
subprogram transferring means for transferring said subprograms out of said subprogram storing means;
subprogram linking means for linking said preceding subprogram with each of said following subprograms through said reading subprogram on the basis of said digital sound processing program displayed by said icon image displaying means;
subprogram judging means for judging whether or not said subprogram linking means is operative to link said preceding subprogram with each of said following subprograms through said reading subprogram on the basis of said digital sound processing program displayed by said icon image displaying means;
executable program producing means for producing a plurality of targeted executable programs from said subprograms linked by said subprogram linking means;
a plurality of executable program storing means for storing said targeted executable programs;
executable program transferring means for transferring each of said targeted executable programs into each of said executable program storing means; and
a plurality of executable program executing means for executing said targeted executable programs stored by said executable program storing means; and
icon image displaying step of displaying said icon images indicative of said subprograms of said digital sound processing program, said icon image displaying means being constituted by a monitor screen, said subprograms including a preceding subprogram and a plurality of following subprograms to be performed after said preceding subprogram is to be performed, each of said preceding subprogram and said following subprograms being to be performed in a processing stage, said icon images including a first icon image indicative of said preceding subprogram and a plurality of second icon images indicative of said following subprograms said subprograms further including a reading subprogram to be performed in a reading stage;
icon image connecting step of connecting said first icon image with each of said second icon images to allow said icon image displaying means to show said digital sound processing program;
subprogram storing step of storing said subprograms;
subprogram transferring step of transferring said subprograms out of said subprogram storing means;
subprogram linking step of linking said preceding subprogram with each of said following subprograms through said reading subprogram on the basis of said digital sound processing program displayed by said icon image displaying means;
subprogram judging step of judging whether or not said subprogram linking means is operative to link said preceding subprogram with each of said following subprograms through said reading subprogram on the basis of said digital sound processing program displayed by said icon image displaying means;
executable program producing step of producing a plurality of targeted executable programs from said subprograms linked by said subprogram linking means;
a plurality of executable program storing step of storing said targeted executable programs;
executable program transferring step of transferring each of said targeted executable programs into each of said executable program storing means; and
a plurality of executable program executing step of executing said targeted executable programs stored by said executable program storing means.

19. A digital sound processing program executing method of executing a digital sound processing program after producing said digital sound processing program from a plurality of subprograms, each of said subprograms being associated with a icon image, comprising:
a preparing step of preparing:
icon image displaying means for displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram, said subprograms further including a reading subprogram to be performed in a reading stage, each of said preceding subprogram and said following subprogram including at least one dividable subprogram to be performed in a processing state, said dividable subprogram including a preceding short-subprogram and a following short-subprogram to be performed after said preceding short-subprogram is to be performed, each of said preceding short-subprogram and said following short-subprogram being to be performed in a processing stage;
subprogram dividing means for dividing said dividable subprogram into said preceding short-subprogram and said following short-subprogram;
icon image connecting means for connecting said first icon image with said second icon image to allow said icon image displaying means to show said digital sound processing program;
subprogram storing means for storing said subprograms;
subprogram transferring means for transferring said subprograms out of said subprogram storing means;
dividable subprogram judging means for judging whether or not said dividable subprogram dividing means is operative to divide said dividable subprograms into said preceding short-subprogram and said following short-subprogram on the basis of said digital sound processing program displayed by said icon image displaying means;
subprogram linking means for linking said preceding short-subprogram with said following short-subprogram through said reading subprogram after said subprogram dividing means is operative to divide said dividable subprogram into said preceding short-subprogram with said following short-subprogram, and linking said preceding subprogram with said following subprogram on the basis of said digital sound processing program displayed by said icon image displaying means;
subprogram judging means for judging whether or not said subprogram linking means is operative to link said preceding subprogram with said following subprogram on the basis of said digital sound processing program displayed by said icon image displaying means;
executable program producing means for producing a targeted executable program from said subprograms linked by said subprogram linking means;
executable program storing means for storing said targeted executable program;
executable program transferring means for transferring said targeted executable program into said executable program storing means; and
executable program executing means for executing said targeted executable program stored by said executable program storing means; and
icon image displaying step of displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram, said subprograms further including a reading subprogram to be performed in a reading stage, each of said preceding subprogram and said following subprogram including at least one dividable subprogram to be performed in a processing state, said dividable subprogram including a preceding short-subprogram and a following short-subprogram to be performed after said preceding short-subprogram is to be performed, each of said preceding short-subprogram and said following short-subprogram being to be performed in a processing stage;
subprogram dividing step of dividing said dividable subprogram into said preceding short-subprogram and said following short-subprogram;
icon image connecting step of connecting said first icon image with said second icon image to allow said icon image displaying means to show said digital sound processing program;
subprogram storing step of storing said subprograms;
subprogram transferring step of transferring said subprograms out of said subprogram storing means;
dividable subprogram judging step of judging whether or not said dividable subprogram dividing means is operative to divide said dividable subprograms into said preceding short-subprogram and said following short-subprogram on the basis of said digital sound processing program displayed by said icon image displaying means;
subprogram linking step of linking said preceding short-subprogram with said following short-subprogram through said reading subprogram after said subprogram dividing means is operative to divide said dividable subprogram into said preceding short-subprogram with said following short-subprogram, and linking said preceding subprogram with said following subprogram on the basis of said digital sound processing program displayed by said icon image displaying means;
subprogram judging step of judging whether or not said subprogram linking means is operative to link said preceding subprogram with said following subprogram on the basis of said digital sound processing program displayed by said icon image displaying means;
executable program producing step of producing a targeted executable program from said subprograms linked by said subprogram linking means;
executable program storing step of storing said targeted executable program;
executable program transferring step of transferring said targeted executable program into said executable program storing means; and
executable program executing step of executing said targeted executable program stored by said executable program storing means.

20. A recodable media having a digital sound processing program recorded therein and capable of being recorded by computers, said digital sound processing program including a plurality of subprograms associated with a plurality of icon images, said digital sound processing program comprising:
icon image displaying step of displaying each of said icon images indicative of said subprograms of said digital sound processing program, said icon image displaying means being constituted by a monitor screen, and said subprograms including a plurality of data processing subprograms and a plurality of data reading subprograms;
first subprogram storing step of storing said data processing subprograms, said data processing subprograms including a preceding subprogram and a plurality of following subprograms to be performed after said preceding subprogram is to be performed, said preceding subprogram being to be performed in at least one writing stage after said preceding subprogram is to be performed in at least one processing stage, and each of said following subprograms being to be performed in at least one processing stage, and said icon images including a first icon image indicative of said preceding subprogram and a second icon image indicative of each of said following subprograms;
digital sound data storing step of storing said digital sound data;
second subprogram storing step of storing said data reading subprogram, each of said data reading subprograms being to be performed in at least one reading stage to read said digital sound data stored by said digital sound data storing means;
subprogram classifying step of classifying each of said preceding subprogram and said following subprograms on the basis of said block diagram indicative of said digital sound processing program displayed by said icon image displaying means;
subprogram linking step of linking said preceding subprogram with each of said following subprograms on the basis of said block diagram indicative of said digital sound processing program displayed by said icon image displaying means;
subprogram judging step of judging whether or not said subprogram linking step is operative to link said preceding subprogram with each of said following subprograms through said reading subprogram on the basis of said block diagram indicative of said digital sound signal processing subprogram displayed by said icon image displaying means;
executable program producing step of producing a targeted executable program from said subprograms linked by said subprogram linking means; and
executable program executing step of executing said targeted executable program produced by said executable program producing means, said executable program executing means being operative to execute said executable program in said writing stage of each of said preceding subprograms to write said digital sound data into said digital sound data storing means after said executable program executing means is operative to execute said executable program in said processing stage of each of said preceding subprograms to process said digital sound data, and said executable program executing means being operative to execute said executable program in said reading stage of each of said reading subprograms to read said digital sound data stored by said digital sound data storing means before said executable program executing means is operative to execute said executable program in said processing stage of said following subprogram to process said digital sound data.

21. A recodable media having a digital sound processing program recorded therein and capable of being recorded by computers, said digital sound processing program including a plurality of subprograms associated with a plurality of icon images, said digital sound processing program comprising:
icon image displaying step of displaying each of said icon images indicative of said subprograms of said digital sound processing program, said icon image displaying means being constituted by a monitor screen, and said subprograms including a plurality of data processing subprograms and a plurality of data reading subprograms;
first subprogram storing step of storing said data processing subprograms, said data processing subprograms including a preceding subprogram and a plurality of following subprograms to be performed after said preceding subprogram is to be performed, said preceding subprogram being to be performed in at least one writing stage after said preceding subprogram is to be performed in at least one processing stage, and each of said following subprograms being to be performed in at least one processing stage, and said icon images including a first icon image indicative of said preceding subprogram and a second icon image indicative of each of said following subprograms;
digital sound data storing step of storing said digital sound data;
second subprogram storing step of storing said data reading subprogram, each of said data reading subprograms being to be performed in at least one reading stage to read said digital sound data stored by said digital sound data storing means;
subprogram classifying step of classifying each of said preceding subprogram and said following subprograms on the basis of said block diagram indicative of said digital sound processing program displayed by said icon image displaying means;
subprogram linking step of linking said preceding subprogram with each of said following subprograms on the basis of said block diagram indicative of said digital sound processing program displayed by said icon image displaying means;
subprogram judging step of judging whether or not said subprogram linking means is operative to link said preceding subprogram with each of said following subprograms through said reading subprogram on the basis of said block diagram indicative of said digital sound signal processing subprogram displayed by said icon image displaying step;
executable program producing step of producing a plurality of targeted executable program from said subprograms linked by said subprogram linking means, said targeted executable program including a first executable program and a second executable program, said first executable program being to be performed in each of said processing stage and said writing stage of said preceding subprogram, and said second executable program being to be performed in said reading stage of said reading subprogram and in each of said processing stages of said following subprogram; and
a plurality of executable program executing step of executing said targeted executable program produced by said executable program producing means, said executable program executing step having a first executable program executing means and a second executable program executing means, said first executable program executing means being operative to execute said first executable program to process said digital sound data in said processing stage of said preceding subprogram before said first executable program executing means is operative to execute said first executable program to write said digital sound data processed in said processing stage into said digital sound data storing step, and said second executable program executing step being operative to execute said second executable program to read said digital sound data stored by said digital sound data storing means in said reading stage of said reading subprogram before said second executable program executing means is operative to execute said second executable program to process said digital sound data read in said reading stage of said reading subprogram in each of said processing stages of said following subprogram.

22. A recodable media having a digital sound processing program recorded therein and capable of being recorded by computers, said digital sound processing program including a plurality of subprograms associated with a plurality of icon images, said digital sound processing program comprising:
icon image displaying step of displaying each of said icon images indicative of said subprograms of said digital sound processing program, said icon image displaying step being constituted by a monitor screen, and said subprograms including a plurality of data processing subprograms and a plurality of data reading subprograms;
first subprogram storing step of storing said data processing subprograms, each of said data processing subprograms being divided into plurality of short-subprograms, said short-subprograms including a preceding short-subprogram and a following short-subprogram to be performed after said preceding short-subprogram is to be performed, each of said preceding short-subprogram and said following short-subprogram being performed in at least one processing state,
digital sound data storing step of storing said digital sound data;
second subprogram storing step of storing said data reading subprogram, each of said data reading subprograms being to be performed in at least one reading stage to read said digital sound data stored by said digital sound data storing means;
subprogram inserting step of inserting said reading subprogram between said preceding short-subprogram and said following short-subprogram on the basis of said block diagram indicative of said digital sound signal processing subprogram displayed by said icon image displaying means;
first subprogram judging step of judging whether or not said subprogram inserting means is operative to insert said reading subprogram between said preceding short-subprogram and said following short-subprogram on the basis of said block diagram indicative of said digital sound signal processing subprogram displayed by said icon image displaying means, said data processing subprograms inserted by said subprogram inserting means including a preceding subprogram and a following subprogram to be performed after said preceding subprogram is to be performed, each of said preceding subprogram and said following subprogram being performed in at least one processing state,
subprogram linking step of linking said preceding subprogram with said following subprogram on the basis of said block diagram indicative of said digital sound signal processing subprogram displayed by said icon image displaying means;
second subprogram judging step of judging whether or not said subprogram linking means is operative to link said preceding subprogram with said following subprogram on the basis of said block diagram indicative of said digital sound signal processing subprogram displayed by said icon image displaying means;
executable program producing step of producing a targeted executable program from said subprograms linked by said subprogram linking means;
executable program executing step of executing said targeted executable program stored by said executable program storing means, said executable program executing step being operative to execute said executable program to process said digital sound data in said processing stage of said preceding short-subprogram of said preceding subprogram before said executable program executing step is operative to execute said executable program to read said digital sound data stored by said digital sound data storing means in said reading stage of said reading subprogram, said executable program executing means being operative to execute said executable program to process both said digital sound data processed in said processing stage of said preceding short-subprogram of said preceding subprogram and said digital sound data read in said reading stage of said reading subprogram in said processing stage of said following short-subprogram of said preceding subprogram after said executable program executing means is operative to execute said executable program to read said digital sound data stored by said digital sound data storing means in said processing stage of said preceding short-subprogram of said preceding subprogram.

23. A recodable media having a digital sound processing program recorded therein and capable of being recorded by computers, said digital sound processing program including a plurality of subprograms associated with a plurality of icon images, said digital sound processing program comprising:
icon image displaying step of displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram, said subprograms further including a reading subprogram to be performed in a reading stage;
icon image connecting step of connecting said first icon image with said second icon image to allow said icon image displaying means to show said digital sound processing program;
subprogram storing step of storing said subprograms;
subprogram transferring step of transferring said subprograms out of said subprogram storing means;
subprogram linking step of linking said preceding subprogram with said following subprogram through said reading subprogram on the basis of said digital sound processing program displayed by said icon image displaying means;
subprogram judging step of judging whether or not said subprogram linking means is operative to link said preceding subprogram with said following subprogram through said reading subprogram on the basis of said digital sound processing program displayed by said icon image displaying means;
executable program producing step of producing a targeted executable program from said subprograms linked by said subprogram linking means;
executable program storing step of storing said targeted executable program;
executable program transferring step of transferring said targeted executable program into said executable program storing means; and
executable program executing step of executing said targeted executable program stored by said executable program storing means.

24. A recodable media having a digital sound processing program recorded therein and capable of being recorded by computers, said digital sound processing program including a plurality of subprograms associated with a plurality of icon images, said digital sound processing program comprising:
icon image displaying step of displaying said icon images indicative of said subprograms of said digital sound processing program, said icon image displaying means being constituted by a monitor screen, said subprograms including a preceding subprogram and a plurality of following subprograms to be performed after said preceding subprogram is to be performed, each of said preceding subprogram and said following subprograms being to be performed in a processing stage, said icon images including a first icon image indicative of said preceding subprogram and a plurality of second icon images indicative of said following subprograms, said subprograms further including a reading subprogram to be performed in a reading stage;
icon image connecting step of connecting said first icon image with each of said second icon images to allow said icon image displaying means to show said digital sound processing program;
subprogram storing step of storing said subprograms;
subprogram transferring step of transferring said subprograms out of said subprogram storing means;
subprogram linking step of linking said preceding subprogram with each of said following subprograms through said reading subprogram on the basis of said digital sound processing program displayed by said icon image displaying means;
subprogram judging step of judging whether or not said subprogram linking means is operative to link said preceding subprogram with each of said following subprograms through said reading subprogram on the basis of said digital sound processing program displayed by said icon image displaying means;
executable program producing step of producing a targeted executable program from said subprograms linked by said subprogram linking means;
executable program storing step of storing said targeted executable program;
executable program transferring step of transferring said targeted executable program into said executable program storing means; and
executable program executing step of executing said targeted executable program stored by said executable program storing means.

25. A recodable media having a digital sound processing program recorded therein and capable of being recorded by computers, said digital sound processing program including a plurality of subprograms associated with a plurality of icon images, said digital sound processing program comprising:
icon image displaying step of displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram said subprograms further including a reading subprogram to be performed in a reading stage;
icon image connecting step of connecting said first icon image with said second icon image to allow said icon image displaying means to show said digital sound processing program;
subprogram storing step of storing said subprograms;
subprogram transferring step of transferring said subprograms out of said subprogram storing means;
subprogram linking step of linking said preceding subprogram with said following subprogram through said reading subprogram on the basis of said digital sound processing program displayed by said icon image displaying means;
subprogram judging step of judging whether or not said subprogram linking means is operative to link said preceding subprogram with said following subprogram through said reading subprogram on the basis of said digital sound processing program displayed by said icon image displaying means;
executable program producing step of producing a plurality of targeted executable programs from said subprograms linked by said subprogram linking means;
a plurality of executable program storing step of respectively storing said targeted executable programs;
executable program transferring step of transferring each of said targeted executable programs into each of said executable program storing means; and
a plurality of executable program executing step of respectively executing said targeted executable programs stored by said executable program storing means.

26. A recodable media having a digital sound processing program recorded therein and capable of being recorded by computers, said digital sound processing program including a plurality of subprograms associated with a plurality of icon images, said digital sound processing program comprising:
icon image displaying step of displaying said icon images indicative of said subprograms of said digital sound processing program, said icon image displaying means being constituted by a monitor screen, said subprograms including a preceding subprogram and a plurality of following subprograms to be performed after said preceding subprogram is to be performed, each of said preceding subprogram and said following subprograms being to be performed in a processing stage, said icon images including a first icon image indicative of said preceding subprogram and a plurality of second icon images indicative of said following subprograms said subprograms further including a reading subprogram to be performed in a reading stage;
icon image connecting step of connecting said first icon image with each of said second icon images to allow said icon image displaying means to show said digital sound processing program;
subprogram storing step of storing said subprograms;
subprogram transferring step of transferring said subprograms out of said subprogram storing means;
subprogram linking step of linking said preceding subprogram with each of said following subprograms through said reading subprogram on the basis of said digital sound processing program displayed by said icon image displaying means;
subprogram judging step of judging whether or not said subprogram linking means is operative to link said preceding subprogram with each of said following subprograms through said reading subprogram on the basis of said digital sound processing program displayed by said icon image displaying means;
executable program producing step of producing a plurality of targeted executable programs from said subprograms linked by said subprogram linking means;
a plurality of executable program storing step of storing said targeted executable programs;
executable program transferring step of transferring each of said targeted executable programs into each of said executable program storing means; and
a plurality of executable program executing step of executing said targeted executable programs stored by said executable program storing means.

27. A recodable media having a digital sound processing program recorded therein and capable of being recorded by computers, said digital sound processing program including a plurality of subprograms associated with a plurality of icon images, said digital sound processing program comprising:
icon image displaying step of displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram, said subprograms further including a reading subprogram to be performed in a reading stage, each of said preceding subprogram and said following subprogram including at least one dividable subprogram to be performed in a processing state, said dividable subprogram including a preceding short-subprogram and a following short-subprogram to be performed after said preceding short-subprogram is to be performed, each of said preceding short-subprogram and said following short-subprogram being to be performed in a processing stage;
subprogram dividing step of dividing said dividable subprogram into said preceding short-subprogram and said following short-subprogram;
icon image connecting step of connecting said first icon image with said second icon image to allow said icon image displaying means to show said digital sound processing program;
subprogram storing step of storing said subprograms;
subprogram transferring step of transferring said subprograms out of said subprogram storing means;
dividable subprogram judging step of judging whether or not said dividable subprogram dividing means is operative to divide said dividable subprograms into said preceding short-subprogram and said following short-subprogram on the basis of said digital sound processing program displayed by said icon image displaying means;
subprogram linking step of linking said preceding short-subprogram with said following short-subprogram through said reading subprogram after said subprogram dividing means is operative to divide said dividable subprogram into said preceding short-subprogram with said following short-subprogram, and linking said preceding subprogram with said following subprogram on the basis of said digital sound processing program displayed by said icon image displaying means;
subprogram judging step of judging whether or not said subprogram linking means is operative to link said preceding subprogram with said following subprogram on the basis of said digital sound processing program displayed by said icon image displaying means;
executable program producing step of producing a targeted executable program from said subprograms linked by said subprogram linking means;
executable program storing step of storing said targeted executable program;
executable program transferring step of transferring said targeted executable program into said executable program storing means; and
executable program executing step of executing said targeted executable program stored by said executable program storing means.

28. A digital audio sound processing system for executing a digital sound processing program after producing said digital sound processing program from a plurality of subprograms, each of said subprograms being associated with an icon image, comprising:
icon image displaying means for displaying each of said icon images indicative of said subprograms of said digital sound processing program, said icon image displaying means being constituted by a monitor screen, and said subprograms including a plurality of data processing subprograms and a plurality of data reading subprograms;
first subprogram storing means for storing said data processing subprograms, said data processing subprograms including a preceding subprogram and a plurality of following subprograms to be performed after said preceding subprogram is to be performed, said preceding subprogram being to be performed in at least one writing stage after said preceding subprogram is to be performed in at least one processing stage, and each of said following subprograms being to be performed in at least one processing stage, and said icon images including a first icon image indicative of said preceding subprogram and a second icon image indicative of each of said following subprograms;
digital sound data storing means for storing said digital sound data;
second subprogram storing means for storing said data reading subprogram, each of said data reading subprograms being to be performed in at least one reading stage to read said digital sound data stored by said digital sound data storing means;
subprogram classifying means for classifying each of said preceding subprogram and said following subprograms on the basis of said block diagram indicative of said digital sound processing program displayed by said icon image displaying means;
subprogram linking means for linking said preceding subprogram with each of said following subprograms on the basis of said block diagram indicative of said digital sound processing program displayed by said icon image displaying means;
subprogram judging means for judging whether or not said subprogram linking means is operative to link said preceding subprogram with each of said following subprograms through said reading subprogram on the basis of said block diagram indicative of said digital sound signal processing subprogram displayed by said icon image displaying means;
executable program producing means for producing a targeted executable program from said subprograms linked by said subprogram linking means; and
executable program executing means for executing said targeted executable program produced by said executable program producing means, said executable program executing means being operative to execute said executable program in said writing stage of each of said preceding subprograms to write said digital sound data into said digital sound data storing means after said executable program executing means is operative to execute said executable program in said processing stage of each of said preceding subprograms to process said digital sound data, and said executable program executing means being operative to execute said executable program in said reading stage of each of said reading subprograms to read said digital sound data stored by said digital sound data storing means before said executable program executing means is operative to execute said executable program in said processing stage of said following subprogram to process said digital sound data.

29. A digital audio sound processing system for executing a digital sound processing program after producing said digital sound processing program from a plurality of subprograms, each of said subprograms being associated with an icon image, comprising:
icon image displaying means for displaying each of said icon images indicative of said subprograms of said digital sound processing program, said icon image displaying means being constituted by a monitor screen, and said subprograms including a plurality of data processing subprograms and a plurality of data reading subprograms;
first subprogram storing means for storing said data processing subprograms, said data processing subprograms including a preceding subprogram and a plurality of following subprograms to be performed after said preceding subprogram is to be performed, said preceding subprogram being to be performed in at least one writing stage after said preceding subprogram is to be performed in at least one processing stage, and each of said following subprograms being to be performed in at least one processing stage, and said icon images including a first icon image indicative of said preceding subprogram and a second icon image indicative of each of said following subprograms;
digital sound data storing means for storing said digital sound data;
second subprogram storing means for storing said data reading subprogram, each of said data reading subprograms being to be performed in at least one reading stage to read said digital sound data stored by said digital sound data storing means;
subprogram classifying means for classifying each of said preceding subprogram and said following subprograms on the basis of said block diagram indicative of said digital sound processing program displayed by said icon image displaying means;
subprogram linking means for linking said preceding subprogram with each of said following subprograms on the basis of said block diagram indicative of said digital sound processing program displayed by said icon image displaying means;
subprogram judging means for judging whether or not said subprogram linking means is operative to link said preceding subprogram with each of said following subprograms through said reading subprogram on the basis of said block diagram indicative of said digital sound signal processing subprogram displayed by said icon image displaying means;
executable program producing means for producing a plurality of targeted executable program from said subprograms linked by said subprogram linking means, said targeted executable program including a first executable program and a second executable program, said first executable program being to be performed in each of said processing stage and said writing stage of said preceding subprogram, and said second executable program being to be performed in said reading stage of said reading subprogram and in each of said processing stages of said following subprogram; and
a plurality of executable program executing means for executing said targeted executable program produced by said executable program producing means, said executable program executing means having a first executable program executing means and a second executable program executing means, said first executable program executing means being operative to execute said first executable program to process said digital sound data in said processing stage of said preceding subprogram before said first executable program executing means is operative to execute said first executable program to write said digital sound data processed in said processing stage into said digital sound data storing means, and said second executable program executing means being operative to execute said second executable program to read said digital sound data stored by said digital sound data storing means in said reading stage of said reading subprogram before said second executable program executing means is operative to execute said second executable program to process said digital sound data read in said reading stage of said reading subprogram in each of said processing stages of said following subprogram.

30. A digital audio sound processing system for executing a digital sound processing program after producing said digital sound processing program from a plurality of subprograms, each of said subprograms being associated with an icon image, comprising:
icon image displaying means for displaying each of said icon images indicative of said subprograms of said digital sound processing program, said icon image displaying means being constituted by a monitor screen, and said subprograms including a plurality of data processing subprograms and a plurality of data reading subprograms;
first subprogram storing means for storing said data processing subprograms, each of said data processing subprograms being divided into plurality of short-subprograms, said short-subprograms including a preceding short-subprogram and a following short-subprogram to be performed after said preceding short-subprogram is to be performed, each of said preceding short-subprogram and said following short-subprogram being performed in at least one processing state,
digital sound data storing means for storing said digital sound data;
second subprogram storing means for storing said data reading subprogram, each of said data reading subprograms being to be performed in at least one reading stage to read said digital sound data stored by said digital sound data storing means;
subprogram inserting means for inserting said reading subprogram between said preceding short-subprogram and said following short-subprogram on the basis of said block diagram indicative of said digital sound signal processing subprogram displayed by said icon image displaying means;
first subprogram judging means for judging whether or not said subprogram inserting means is operative to insert said reading subprogram between said preceding short-subprogram and said following short-subprogram on the basis of said block diagram indicative of said digital sound signal processing subprogram displayed by said icon image displaying means, said data processing subprograms inserted by said subprogram inserting means including a preceding subprogram and a following subprogram to be performed after said preceding subprogram is to be performed, each of said preceding subprogram and said following subprogram being performed in at least one processing state,
subprogram linking means for linking said preceding subprogram with said following subprogram on the basis of said block diagram indicative of said digital sound signal processing subprogram displayed by said icon image displaying means;
second subprogram judging means for judging whether or not said subprogram linking means is operative to link said preceding subprogram with said following subprogram on the basis of said block diagram indicative of said digital sound signal processing subprogram displayed by said icon image displaying means;
executable program producing means for producing a targeted executable program from said subprograms linked by said subprogram linking means;
executable program executing means for executing said targeted executable program stored by said executable program storing means, said executable program executing means being operative to execute said executable program to process said digital sound data in said processing stage of said preceding short-subprogram of said preceding subprogram before said executable program executing means is operative to execute said executable program to read said digital sound data stored by said digital sound data storing means in said reading stage of said reading subprogram, said executable program executing means being operative to execute said executable program to process both said digital sound data processed in said processing stage of said preceding short-subprogram of said preceding subprogram and said digital sound data read in said reading stage of said reading subprogram in said processing stage of said following short-subprogram of said preceding subprogram after said executable program executing means is operative to execute said executable program to read said digital sound data stored by said digital sound data storing means in said processing stage of said preceding short-subprogram of said preceding subprogram.

31. A digital audio sound processing system for processing a digital audio sound data in a plurality of processing stages to execute a digital sound processing program after producing said digital sound processing program from a plurality of subprograms, each of said subprograms being associated with an icon image, comprising:
icon image displaying means for displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram, said subprograms further including a reading subprogram to be performed in a reading stage;
icon image connecting means for connecting said first icon image with said second icon image to allow said icon image displaying means to show said digital sound processing program;
subprogram storing means for storing said subprograms;
subprogram transferring means for transferring said subprograms out of said subprogram storing means;
subprogram linking means for linking said preceding subprogram with said following subprogram through said reading subprogram on the basis of said digital sound processing program displayed by said icon image displaying means;
subprogram judging means for judging whether or not said subprogram linking means is operative to link said preceding subprogram with said following subprogram through said reading subprogram on the basis of said digital sound processing program displayed by said icon image displaying means;
executable program producing means for producing a targeted executable program from said subprograms linked by said subprogram linking means;
executable program storing means for storing said targeted executable program;
executable program transferring means for transferring said targeted executable program into said executable program storing means; and
executable program executing means for executing said targeted executable program stored by said executable program storing means.

32. A digital audio sound processing system for processing a digital audio sound data in a plurality of processing stages to execute a digital sound processing program after producing said digital sound processing program from a plurality of subprograms, each of said subprograms being associated with an icon image, comprising:
icon image displaying means for displaying said icon images indicative of said subprograms of said digital sound processing program, said icon image displaying means being constituted by a monitor screen, said subprograms including a preceding subprogram and a plurality of following subprograms to be performed after said preceding subprogram is to be performed, each of said preceding subprogram and said following subprograms being to be performed in a processing stage, said icon images including a first icon image indicative of said preceding subprogram and a plurality of second icon images indicative of said following subprograms, said subprograms further including a reading subprogram to be performed in a reading stage;
icon image connecting means for connecting said first icon image with each of said second icon images to allow said icon image displaying means to show said digital sound processing program;
subprogram storing means for storing said subprograms;
subprogram transferring means for transferring said subprograms out of said subprogram storing means;
subprogram linking means for linking said preceding subprogram with each of said following subprograms through said reading subprogram on the basis of said digital sound processing program displayed by said icon image displaying means;
subprogram judging means for judging whether or not said subprogram linking means is operative to link said preceding subprogram with each of said following subprograms through said reading subprogram on the basis of said digital sound processing program displayed by said icon image displaying means;
executable program producing means for producing a targeted executable program from said subprograms linked by said subprogram linking means;
executable program storing means for storing said targeted executable program;
executable program transferring means for transferring said targeted executable program into said executable program storing means; and
executable program executing means for executing said targeted executable program stored by said executable program storing means.

33. A digital audio sound processing system for processing a digital audio sound data in a plurality of processing stages to execute a digital sound processing program after producing said digital sound processing program from a plurality of subprograms, each of said subprograms being associated with an icon image, comprising:
icon image displaying means for displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram said subprograms further including a reading subprogram to be performed in a reading stage;
icon image connecting means for connecting said first icon image with said second icon image to allow said icon image displaying means to show said digital sound processing program;
subprogram storing means for storing said subprograms;
subprogram transferring means for transferring said subprograms out of said subprogram storing means;
subprogram linking means for linking said preceding subprogram with said following subprogram through said reading subprogram on the basis of said digital sound processing program displayed by said icon image displaying means;
subprogram judging means for judging whether or not said subprogram linking means is operative to link said preceding subprogram with said following subprogram through said reading subprogram on the basis of said digital sound processing program displayed by said icon image displaying means;
executable program producing means for producing a plurality of targeted executable programs from said subprograms linked by said subprogram linking means;
a plurality of executable program storing means for respectively storing said targeted executable programs;
executable program transferring means for transferring each of said targeted executable programs into each of said executable program storing means; and
a plurality of executable program executing means for respectively executing said targeted executable programs stored by said executable program storing means.

34. A digital audio sound processing system for processing a digital audio sound data in a plurality of processing stages to execute a digital sound processing program after producing said digital sound processing program from a plurality of subprograms, each of said subprograms being associated with an icon image, comprising:
icon image displaying means for displaying said icon images indicative of said subprograms of said digital sound processing program, said icon image displaying means being constituted by a monitor screen, said subprograms including a preceding subprogram and a plurality of following subprograms to be performed after said preceding subprogram is to be performed, each of said preceding subprogram and said following subprograms being to be performed in a processing stage, said icon images including a first icon image indicative of said preceding subprogram and a plurality of second icon images indicative of said following subprograms said subprograms further including a reading subprogram to be performed in a reading stage;
icon image connecting means for connecting said first icon image with each of said second icon images to allow said icon image displaying means to show said digital sound processing program;
subprogram storing means for storing said subprograms;
subprogram transferring means for transferring said subprograms out of said subprogram storing means;
subprogram linking means for linking said preceding subprogram with each of said following subprograms through said reading subprogram on the basis of said digital sound processing program displayed by said icon image displaying means;
subprogram judging means for judging whether or not said subprogram linking means is operative to link said preceding subprogram with each of said following subprograms through said reading subprogram on the basis of said digital sound processing program displayed by said icon image displaying means;
executable program producing means for producing a plurality of targeted executable programs from said subprograms linked by said subprogram linking means;
a plurality of executable program storing means for storing said targeted executable programs;
executable program transferring means for transferring each of said targeted executable programs into each of said executable program storing means; and
a plurality of executable program executing means for executing said targeted executable programs stored by said executable program storing means.

35. A digital audio sound processing system for processing a digital audio sound data in a plurality of processing stages to execute a digital sound processing program after producing said digital sound processing program from a plurality of subprograms, each of said subprograms being associated with an icon image, comprising:
icon image displaying means for displaying said icon images indicative of said subprograms of said digital sound processing program, said icon image displaying means being constituted by a monitor screen, said subprograms including a preceding subprogram and a following subprogram to be performed after said preceding subprogram is to be performed, each of said preceding subprogram and said following subprogram being to be performed in a processing stage, said icon images including a first icon image indicative of said preceding subprogram and a second icon image indicative of said following subprogram, said subprograms further including a reading subprogram to be performed in a reading stage, each of said preceding subprogram and said following subprogram including at least one dividable subprogram to be performed in a processing state, said dividable subprogram including a preceding short-subprogram and a following short-subprogram to be performed after said preceding short-subprogram is to be performed, each of said preceding short-subprogram and said following short-subprogram being to be performed in a processing stage;
subprogram dividing means for dividing said dividable subprogram into said preceding short-subprogram and said following short-subprogram;
icon image connecting means for connecting said first icon image with said second icon image to allow said icon image displaying means to show said digital sound processing program;
subprogram storing means for storing said subprograms;
subprogram transferring means for transferring said subprograms out of said subprogram storing means;
dividable subprogram judging means for judging whether or not said dividable subprogram dividing means is operative to divide said dividable subprograms into said preceding short-subprogram and said following short-subprogram on the basis of said digital sound processing program displayed by said icon image displaying means;
subprogram linking means for linking said preceding short-subprogram with said following short-subprogram through said reading subprogram after said subprogram dividing means is operative to divide said dividable subprogram into said preceding short-subprogram with said following short-subprogram, and linking said preceding subprogram with said following subprogram on the basis of said digital sound processing program displayed by said icon image displaying means;
subprogram judging means for judging whether or not said subprogram linking means is operative to link said preceding subprogram with said following subprogram on the basis of said digital sound processing program displayed by said icon image displaying means;
executable program producing means for producing a targeted executable program from said subprograms linked by said subprogram linking means;
executable program storing means for storing said targeted executable program;
executable program transferring means for transferring said targeted executable program into said executable program storing means; and
executable program executing means for executing said targeted executable program stored by said executable program storing means.
